(19) United States
(12) Patent Application Publication
(10) Pub. No.: US 2012/0144115 A1
(43) Pub. Date: Jun. 7, 2012

(54) STORAGE MEDIUM ADAPTER, INFORMATION WRITING DEVICE AND INFORMATION WRITING SYSTEM

(75) Inventors: Masanori MITSUZUMI, Osaka (JP); Takanori OKADA, Osaka (JP)

(73) Assignee: PANASONIC CORPORATION, Osaka (JP)

(21) Appl. No.: 13/309,831

(22) Filed: Dec. 2, 2011

(30) Foreign Application Priority Data
Dec. 6, 2010 (JP) 2010-271054
Feb. 17, 2011 (JP) 2011-031583
Nov. 9, 2011 (JP) 2011-245841

(51) Int. Cl. G06F 12/00

(52) U.S. Cl. 711/115; 711/E12.001

(57) ABSTRACT

A storage medium adapter 200 includes storage medium interfaces 230, 240, to which multiple storage media 250, 260 are to be connected, a host interface 210, which is to be connected to an external device, and a control section 220, which is electrically connected to the storage medium interfaces 230, 240 and the host interface 210. The control section 220 determines whether or not the same data can be written on those storage media 250, 260 simultaneously. If the answer is YES, the control section 220 writes data that has been received by way of the host interface 210 on the respective storage media.

### BACKGROUND OF THE INVENTION

1. Field of the Invention

The present invention relates to a technique for performing a write operation on multiple storage media simultaneously by using a storage medium adapter, to/from which those storage media are attachable and removable, and an information writing device.

2. Description of the Related Art

Cameras and recorders, which use a memory card as their storage medium, have become more and more popular these days. However, some people might lose a memory card on which a lot of data has been written or might erase some of the data by mistake. Thus, as a precaution against such an unwanted situation, a recorder that writes the same data on multiple memory cards redundantly has been proposed in Japanese Patent Publication No. 3615780 (which will be referred to herein as Patent Document No. 1 for convenience sake), for example.

The recorder disclosed in Patent Document No. 1 writes the data of the same still picture on multiple memory cards. That is why when a still picture is shot, data of the same still picture is stored on multiple memory cards. For that reason, there is no need to copy the data of the still picture from one memory card to another for backup purposes.

The recorder disclosed in Patent Document No. 1, however, is supposed to store a still picture. Therefore, with the configuration of such a recorder, it is difficult to write a huge amount of data such as a moving picture on multiple storage media simultaneously.

To write data of the same moving picture on multiple memory cards simultaneously, the internal configuration of the recorder should have a multiplexed design that enables such simultaneous writing. Specifically, in that case, multiple card slots and multiple card interface circuits should be provided for those memory cards and the circuits and buses through which moving picture data is going to flow should have transfer capability that is high enough to transmit multiple streams of moving picture data at the same time. As a result, increased pieces of hardware are required and the cost of such a recorder becomes higher than ordinary ones.

Moreover, most of currently available cameras and recorders that use a memory card as a storage medium do not have such a simultaneous write function and are usually designed to write one material on one memory card at a time. That is why those cameras and recorders are often designed to have only one card slot and their internal configuration is designed in most cases to have the ability to transmit just one stream of moving picture data at a time. And it is difficult to add a simultaneous write function to such a design afterward.

It is therefore an object of the present invention to provide a technique for adding such a simultaneous write function afterward to a recorder that does not have the ability to write the same data on multiple storage media at the same time.

### SUMMARY OF THE INVENTION

A storage medium adapter according to the present invention is designed to be an adapter to/from which multiple storage media are attachable and removable. The adapter includes: storage medium interfaces, to which the multiple storage media are to be connected; a host interface, which is to be connected to an external device; and a control section, which is electrically connected to the storage medium interfaces and the host interface. The control section determines, based on information that has been obtained from the multiple storage media through the storage medium interfaces, whether or not same data can be written on those storage media simultaneously. If it turns out that the same data can be written on the multiple storage media simultaneously, the control section writes data that has been received by way of the host interface on the respective storage media.

In one preferred embodiment, the control section determines, based on at least one of pieces of information about the storage capacities, transfer capabilities, file system formats, and spaces left of the respective storage media, whether or not the same data can be written on the multiple storage media simultaneously.

In another preferred embodiment, if the control section has received, by way of the host interface, a write command to write data on the multiple storage media, the control section copies the write command and transmits the copied write command to the respective storage media.

In still another preferred embodiment, if the control section has received, by way of the host interface, a read command to read data from the multiple storage media, the control section transmits the read command to one of those storage media and then forwards a response from that storage medium by way of the host interface.

An information writing system according to the present invention includes a storage medium adapter, to/from which multiple storage media are attachable and removable, and an information writing device, to/from which the storage medium adapter is connectable and disconnectible. The information writing device includes: an adapter interface, to which the storage medium adapter is to be connected; and a first control section, which is electrically connected to the adapter interface. The storage medium adapter includes: storage medium interfaces, to which the multiple storage media are to be connected; a host interface, which is to be connected to the information writing device; and a second control section, which is electrically connected to the storage medium interfaces and the host interface. The first control section determines, based on information about the multiple storage media that has been obtained from the storage medium adapter through the adapter interface, whether or not same data can be written on those storage media simultaneously. If it turns out that the same data can be written on the multiple storage media simultaneously, the first control section transmits a write command to write data to the storage medium adapter by way of the adapter interface. If the second control section has received the write command by way of the host interface, the second control section copies the write command and transmits the copied write command to the respective storage media by way of the storage medium interfaces.

In one preferred embodiment, the first control section determines, based on at least one of pieces of information about the storage capacities, transfer capabilities, file system formats, and spaces left of the respective storage media, whether or not the same data can be written on the multiple storage media simultaneously.

In another preferred embodiment, the second control section is able to change its modes of operation from a first mode in which a command that has been received from the information writing device by way of the host interface is transmitted to every one of the storage media, into a second mode in which the command is transmitted to only one of the storage media, and vice versa.

In still another preferred embodiment, the first control section detects the start address of the data area of each said storage medium, sets each said storage medium's start address detected to the storage medium adapter, and then transmits the write command to the storage medium adapter. On receiving the write command, the second control section determines, based on each said storage medium's start address that has been set, where data should be written on each said storage medium.

In this particular preferred embodiment, the write command specifies, by an address that is defined with respect to the start address of each said storage medium's data area, where data should be written. On receiving the write command, the second control section adds each said storage medium's start address to the address specified by the write command and then writes the data at an address that is specified by the sum of the two addresses.

In yet another preferred embodiment, the first control section is able to transmit a first kind of command that gives an instruction to only a particular one of the storage media at a time and a second kind of command that gives an instruction to every one of the storage media at the same time, obtains file management information from each said storage medium by using the first kind of command, and writes data on the multiple storage media simultaneously by using the write command as the second kind of command.

In yet another preferred embodiment, before writing data on the multiple storage media simultaneously, the first control section obtains information about the performance of each said storage medium and the file management information thereof by using the first kind of command, and determines, based on the information about each said storage medium's performance and the file management information thus obtained, whether or not data can be written on the multiple storage media simultaneously.

An information writing device according to the present invention is designed to be a device to/from which multiple storage media are attachable and removable. The information writing device includes: storage medium interfaces, to which the multiple storage media are to be connected; a first control section, which issues a write command to write data on the multiple storage media simultaneously; and a second control section, which is electrically connected to the storage medium interfaces and the first control section. The first control section detects the start address of the data area of each said storage medium, sets each said storage medium's start address detected to the second control section, and then transmits the write command to the second control section. On receiving the write command, the second control section determines, based on each said storage medium's start address that has been set, where data should be written on each said storage medium.

In one preferred embodiment, the write command specifies, by an address that is defined with respect to the start address of each said storage medium's data area, where data should be written. On receiving the write command, the second control section adds each said storage medium's start address to the address specified by the write command and then writes the data at an address that is specified by the sum of the two addresses.

In another preferred embodiment, the first control section is able to transmit a first kind of command that gives an instruction to only a particular one of the storage media at a time and a second kind of command that gives an instruction to every one of the storage media at the same time, obtains file management information from each said storage medium by using the first kind of command, and writes data on the multiple storage media simultaneously by using the write command as the second kind of command.

In still another preferred embodiment, before writing data on the multiple storage media simultaneously, the first control section obtains information about the performance of each said storage medium and the file management information thereof by using the first kind of command, and determines, based on the information about each said storage medium's performance and the file management information thus obtained, whether or not data can be written on the multiple storage media simultaneously.

According to the present invention, a simultaneous write function can be added afterward to an information writing device that does not have the ability to write the same data on multiple storage media simultaneously. Consequently, without taking time to copy the data that has just been written for backup purposes, the material that has just been written and the backup material can be obtained at the same time.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a block diagram illustrating a configuration for an information writing device as a first specific preferred embodiment of the present invention.

FIG. 2 is a block diagram illustrating a configuration for the memory card adapter of the first preferred embodiment of the present invention.

FIG. 3 is a flowchart showing the procedure of a card testing method according to the first preferred embodiment.

FIG. 4 is a block diagram illustrating a configuration for an information writing device as a second specific preferred embodiment of the present invention.

FIG. 5 is a block diagram illustrating a configuration for the memory card adapter of the second preferred embodiment of the present invention.

FIG. 6 is a flowchart showing the procedure of a card testing method according to the second preferred embodiment.

FIG. 7 is a block diagram illustrating a configuration for an information writing device as a third specific preferred embodiment of the present invention.

FIG. 8 is a block diagram illustrating a configuration for the memory card adapter of the third preferred embodiment of the present invention.

FIG. 9 is a block diagram illustrating exemplary arrangements of data in the memory cards of the third preferred embodiment.

FIG. 10 is a flowchart showing the procedure of a card testing method according to the third preferred embodiment.

FIG. 11 is a flowchart showing the procedure of an AV data writing method according to the third preferred embodiment.

FIG. 12 is a block diagram illustrating a configuration for an information writing device as a fourth specific preferred embodiment of the present invention.

FIG. 13 is a flowchart showing the procedure of a card testing method according to the fourth preferred embodiment.

FIG. 14 is a flowchart showing the procedure of an AV data writing method according to the fourth preferred embodiment.

### DETAILED DESCRIPTION OF PREFERRED EMBODIMENTS

Hereinafter, preferred embodiments of the present invention will be described with reference to the accompanying drawings. In this description, to write the same data on multiple storage media substantially simultaneously will be referred to herein as “simultaneous writing”. It should be noted, however, that the “simultaneous writing” refers herein to not only a situation where the write operation is performed on multiple storage media at exactly the same time but also a situation where the write operation is performed on those media at slightly different times as well.

### Embodiment 1

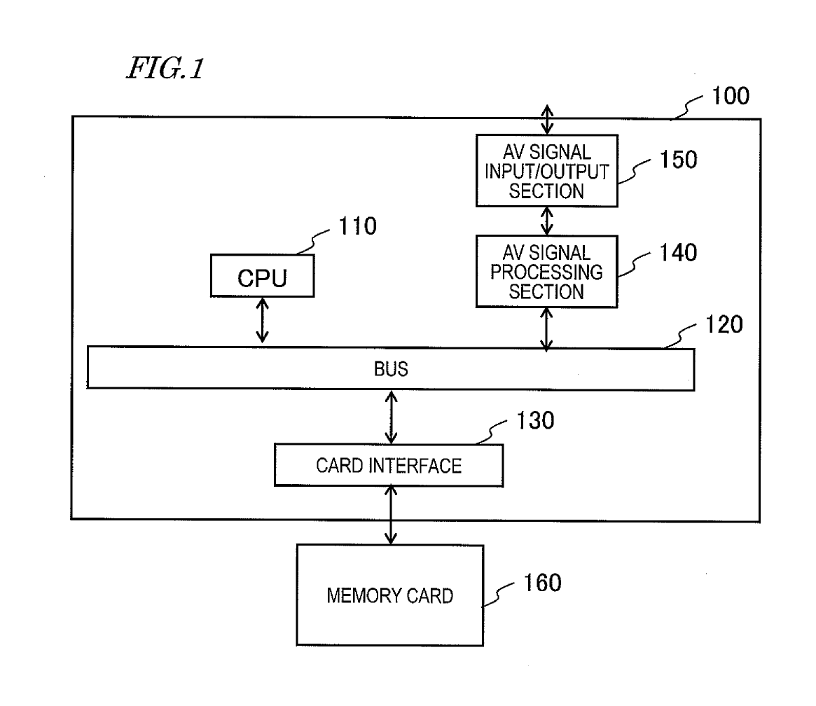

FIG. 1 is a block diagram illustrating a configuration for an information writing device as a first specific preferred embodiment of the present invention. As shown in FIG. 1, the information writing device 100 of this preferred embodiment includes a CPU 110, a bus 120, a card interface 130, an AV signal processing section 140, and an AV signal input/output section 150. One memory card 160 can be inserted into the card interface 130 of the information writing device 100 at a time.

To the AV signal input/output section 150, connected is a video or audio input device such as an image sensor, a lens or a microphone or a video or audio output device such as a monitor or a loudspeaker. Optionally, the AV signal input/output section 150 may also be telecommunications means that receives or sends out an AV signal from/to an external device.

The AV signal processing section 140 performs signal processing on video or audio, and has an encoder or decoder function and a buffer that temporarily stores data.

The CPU 110 has an arithmetic logic processor, a main memory, and a storage area to store a program that operates the CPU just like any normal central processing unit. A file system that is designed to write desired data on a storage medium as a file has been installed in this CPU 110.

The memory card 160 can be connected both mechanically and electrically to the card interface 130 and holds the memory card 160 in a readily removable state.

In writing video or audio on the memory card 160, a video signal or an audio signal that has been input through the AV signal input/output section 150 is processed by the AV signal processing section 140 to be encoded digital AV data. The AV data is temporarily stored in a buffer (not shown) and will then be sent as a file through the bus 120 to, and written on, the memory card 160 that is connected to the card interface 130 under the instruction given by the CPU 110.

As described above, this information writing device 100 has the ability to write AV data on the memory card 160. According to the configuration of the information writing device 100 shown in FIG. 1, however, there is only one card interface 130 and only one memory card 160 can be inserted at a time. The path that leads from the AV signal processing section 140 to the card interface 130 through the bus 120 has transfer capability to pass only one stream of AV data and does not have transfer capability to pass multiple streams of AV data at the same time to perform the simultaneous write operation.

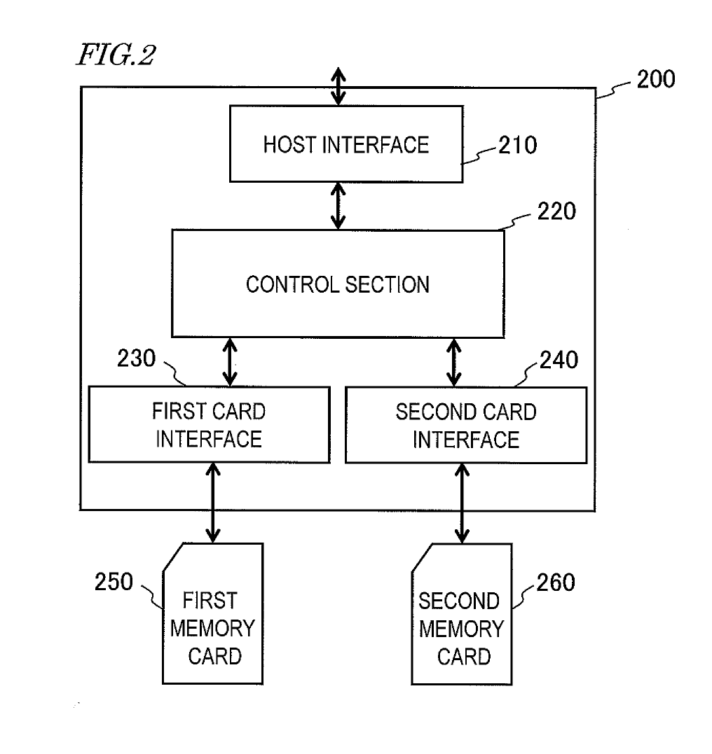

Consequently, only with the information writing device 100 that has the configuration shown in FIG. 1, it is difficult to write the same data on multiple memory cards simultaneously for backup purposes. Thus, according to this preferred embodiment, the memory card 160 is replaced with the memory card adapter 200 shown in FIG. 2.

FIG. 2 is a block diagram illustrating a general configuration for the memory card adapter 200 of this preferred embodiment. As shown in FIG. 2, the memory card adapter 200 includes a host interface 210 to be connected to an external device, a first card interface 230 to which a first memory card 250 is inserted, a second card interface 240 to which a second memory card 260 is inserted, and a control section 220 that controls a data writing operation.

The external dimensions of the memory card adapter 200 and the structure of the host interface 210 are the same as those of the memory card 160 shown in FIG. 1. That is to say, it is possible to insert the memory card adapter 200, instead of the memory card 160, into the card interface 130 of the information writing device 100.

The host interface 210 can be connected both mechanically and electrically to the card interface 130 of the information writing device 100. The control section 220 is electrically connected to the host interface 210 and the first and second card interfaces 230 and 240 and performs an overall control on the entire memory card adapter 200. The first and second card interfaces 230 and 240 can be mechanically and electrically connected to the first and second memory cards 250 and 260, respectively.

Two memory cards can be attached to this memory card adapter 200. The first and second memory cards 250 and 260 are inserted into the first and second card interfaces 230 and 240, respectively. Each of the first and second memory cards 250 and 260 is readily attachable and removable to/from the memory card adapter 200 and is designed not to protrude from the outer surface of the memory card adapter 200 when attached to the memory card adapter 200. That is why even when the first and second memory cards 250 and 260 are inserted into the memory card adapter 200, the memory card adapter 200 can still be connected to the information writing device 100.

And when the memory card adapter 200 is inserted into the information writing device 100, the memory card adapter 200 is connected to the card interface 130 of the information writing device 100 by way of the host interface 210. As a result of this connection, power is supplied to the memory card adapter 200 and the control section 220 starts to operate.

The control section 220 accesses the first and second memory cards 250 and 260 by way of the first and second card interfaces 230 and 240, respectively. That is to say, the control section 220 sees, by way of the first and second card interfaces 230 and 240, if the first and second memory cards 250 and 260 are both connected.

The basic idea of the memory card adapter 200 of this preferred embodiment is to copy the data that is going to be written by the information writing device 100 on a single memory card inside of the memory card adapter 200 and write the copied data on both of the first and second memory cards 250 and 260 simultaneously. To get this simultaneous write operation done, it is preferred that the first and second memory cards 250 and 260 satisfy the same condition and have exactly the same status.

As a conventional structure for use in a writing device to be loaded with multiple storage media at a time, a RAID (redundant arrays of independent/inexpensive disks) structure is known. In the RAID structure, multiple storage media that have quite the same specifications are fixed in advance in a device and used under uniform management. That is why with such a structure, the specifications and statuses of multiple storage media can always be the same.

On the other hand, according to the memory card adapter 200 of this preferred embodiment, the first and second memory cards 250 and 260 are used in a readily attachable and removable state. That is why nobody knows what types of memory cards will be inserted in what status into this memory card adapter 200. For that reason, to get the simultaneous write operation done, the processing of comparing and checking out the specifications and statuses of the storage media should be carried out according to this preferred embodiment.

After having confirmed that first and second memory cards 250 and 260 are both connected and accessible, the control section 220 sees if the first and second memory cards 250 and 260 satisfy the condition of simultaneous writing. Hereinafter, it will be described with reference to a flowchart how to examine whether the condition of simultaneous writing is satisfied or not.

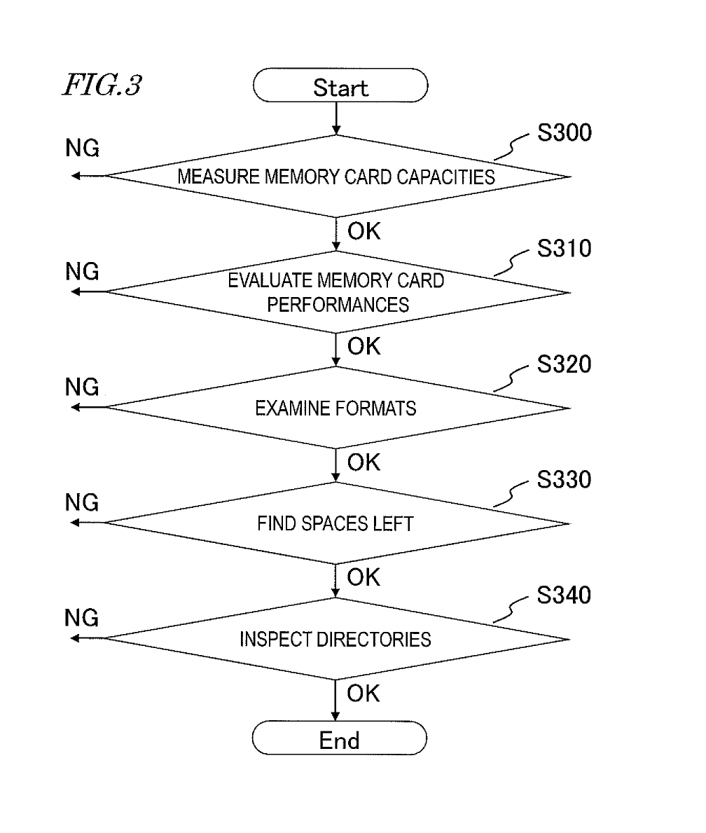

FIG. 3 is a flowchart showing the procedure of a memory card testing method according to this preferred embodiment. As shown in FIG. 3, the memory cards have their storage capacities measured in Step S300, have their performances evaluated in Step S310, have their formats examined in Step S320, have their spaces left found in Step S330 and then have their directories inspected in Step S340.

Hereinafter, the respective processing steps of the memory card testing method shown in FIG. 3 will be described in detail one by one.

### Measure Storage Capacities

First of all, in Step S300, the control section 220 measures the overall storage capacities of the first and second memory cards 250 and 260. For that purpose, the control section 220 issues and sends a command to the first memory card 250 by way of the first card interface 230 and gets a numerical value representing the overall storage capacity of the card from the first memory card 250. Next, the control section 220 issues and sends a command to the second memory card 260 by way of the second card interface 240 and gets a numerical value representing the overall storage capacity of the card from the second memory card 260. And then the control section 220 compares the respective overall storage capacities of the first and second memory cards 250 and 260 thus obtained. If the control section 220 has found, as a result of the comparison, that the first and second memory cards 250 and 260 have the same storage capacity, then the control section 220 decides that there is no storage capacity problem (OK) and the process advances to the next processing step S310. On the other hand, if it turns out that the first and second memory cards 250 and 260 have different overall storage capacities, then the control section 220 decides that the simultaneous write operation cannot get done (NG) to end this testing process.

Specifically, this processing step S300 may be performed in the following manner. For example, if the first and second memory cards 250 and 260 have the same storage capacity (e.g., 8 GB), then the decision is OK. However, if the first and second memory cards 250 and 260 have mutually different storage capacities (e.g., if one of the two memory cards has a storage capacity of 8 GB and the other has a storage capacity of 4 GB), then the decision is NG.

### Evaluate Performances

In the next processing step S310, the control section 220 evaluates the performances of the first and second memory cards 250 and 260 that are currently attached to the memory card adapter 200. In this case, the “performance” of a memory card is evaluated by the data read or write rate of the memory card. Depending on the standard that a given memory card is compliant with, a value indicating the performance of the memory card can be obtained by issuing a command.

With respect to a memory card that is compliant with such a standard, the control section 220 issues and sends a command by way of the first card interface 230, thereby getting a numerical value indicating the card's performance from the first memory card 250. Next, the control section 220 issues and sends a command by way of the second card interface 240, thereby getting a numerical value indicating the card's performance from the second memory card 260.

These values indicating the card performances of the first and second memory cards 250 and 260 (which will be referred to herein as “performance values”) are checked out to see if both of these values are equal to or greater than a predetermined performance value. In this description, the “predetermined performance value” is a value representing how high the performance of a card should be to get the simultaneous write operation done, and may be a value that has been determined uniquely based on the bit rate of AV data or the overhead of the software. In this memory card adapter 200, the predetermined performance value is stored in advance in a memory (not shown), for example. If the performance values of the first and second memory cards 250 and 260 both turn out to be equal to or greater than the predetermined performance value, the control section 220 decides that there is no performance value problem (OK) and the process advances to the next processing step S320. However, if the performance value(s) of one or both of the first and second memory cards 250 and 260 turn(s) out to be less than the predetermined performance value, the control section 220 decides that the simultaneous write operation cannot get done (NG) to end this testing process.

As for an actual example of such a value indicating the performance of a memory card, a speed class value is defined by the SD Memory Card standard. For example, if an SD memory card has a speed class value of 4, then it means that its data read or write rate is at least 4 MB/s (megabytes per second). This speed class value can be detected by issuing a command to a given memory card. As for SD memory cards, speed class values of 2, 6 and 10 have also been standardized to represent minimum data read or write rates of 2 MB/s, 6 MB/s and 10 MB/s, respectively.

Specifically, the processing step S310 shown in FIG. 3 may be performed in the following manner. For example, suppose the performance values of the first and second memory cards 250 and 260 have turned out to be a speed class of 4 and a speed class of 6, respectively. In this case, if the predetermined performance value to get the simultaneous write operation done is 4 MB/s, then the performance values of the first and second memory cards 250 and 260 are both higher than the speed class of 4 that is the predetermined performance value, and therefore, the decision is OK. However, if the performance value of at least one of the first and second memory cards 250 and 260 has turned out to be a speed class of 2, then the performance value is lower than the speed class of 4 that is the predetermined performance value, and therefore, the decision is NG in that case.

### Examine Formats

In the next processing step S320, the control section 220 examines the formats of the first and second memory cards 250 and 260 that are currently attached to the memory card adapter 200. In this case, the “format” means the format of the file system. The control section 220 examines whether a particular partition has been formatted compliant with a predetermined file system. In memory cards, among other things, most of them will have their formats defined by the standard. For example, according to the SD Memory Card standard, the position and size of a partition, the type of the file system, and various parameters of the file system are defined in detail according to the storage capacity of the card.

Thus, in this processing step S320, the control section 220 examines whether or not the formats of the first and second memory cards 250 and 260 are compliant with the standard. If the control section 220 has found that the first and second memory cards 250 and 260 are both compliant with the standard, then the control section 220 decides that there is no format compliance problem (OK) and the process advances to the next processing step S330. On the other hand, if it turns out that at least one of the first and second memory cards 250 and 260 fails to comply with the standard, then the control section 220 decides that the simultaneous write operation cannot get done (NG) to end this testing process.

It should be noted that the management information of a file system includes a piece of management information that is regarded as optional, not indispensable, according to the standard and a piece of management information that allows the user to set parameters with a lot of freedom. Thus, in this processing step S320, as for such a piece of management information with a lot of freedom, the control section 220 may examine not just whether or not the management information is compliant with the file system standard of the memory card but also whether or not the parameters of respective pieces of management information of the first and second memory cards 250 and 260 have the same condition as well. Nevertheless, among various pieces of file system management information, the control section 220 of this preferred embodiment does not examine information about directories in this processing step S320 but will examine it in the processing step to be described later.

Specifically, this format examining processing step S320 may be performed in the following manner. First of all, the control section 220 issues and sends a command by way of the first card interface 230, thereby retrieving data from a predetermined address on the first memory card 250. More specifically, the control section 220 retrieves data of a predetermined size from an address with a PSN (physical sector number) of zero, which is the start address of the storage area. This data includes information about a master boot record including a partition table. The control section 220 examines whether or not the content of this information is compliant with the memory card's standard.

Also, the control section 220 can find the top address of the partition by reference to the partition table. Next, the control section 220 retrieves data of a predetermined size from the top address of the partition. This data includes the boot record of a predetermined file system. And by retrieving that data, various parameters of the file system can be obtained. And the control section 220 sees if those various parameters of the file system are compliant with the memory card's standard.

Furthermore, by reference to the content of the boot record of the file system, the control section 220 can find the addresses of other pieces of management information that are stored elsewhere. The control section 220 retrieves those pieces of management information from the memory card 250, too, and also examines whether or not those pieces of management information are compliant with the memory card's standard.

By carrying out these examinations, the format of the first memory card 250 can get examined. The control section 220 performs the same examinations on the second memory card 260, too. That is to say, the control section 220 issues and sends a command by way of the second card interface 240, retrieves data from predetermined addresses on the second memory card 260, and then performs similar examinations.

Among various items of data to be examined, as for the management information that is regarded as optional according to the memory card's standard and the management information that allows the user to set with a lot of freedom, the control section 220 sees if the first and second memory cards 250 and 260 have parameters under the same condition.

For instance, if such a piece of management information that is regarded as optional according to the standard is stored on both or neither of the first and second memory cards 250 and 260, then the control section 220 decides that it is OK. On the other hand, if the optional piece of management information is stored on one of the first and second memory cards 250 and 260 but not stored on the other, then the control section 220 decides that it is NG.

Examples of such a piece of management information that allows the user to set with a lot of freedom include the number of management tables of the file system. In some cases, there is no problem no matter whether the number of management tables of the file system is one or two. In such a situation, if both of the first and second memory cards 250 and 260 are supposed to have only one management table or two management tables, then the control section decides that it is OK. On the other hand, if one of the first and second memory cards 250 and 260 is supposed to have one management table and the other is supposed to have two management tables, then the control section 220 decides that it is NG.

### Find Spaces Left

In the next processing step S330, the control section 220 finds how much space is left in the first and second memory cards 250 and 260 that are currently attached to the memory card adapter 200. In general, the storage area of a memory card is managed on the basis of a unit of a predetermined size, which is called a “sector” or a “cluster” according to the file system, and the space left is also managed on the basis of the same unit. One of the conditions for getting the simultaneous write operation done according to this preferred embodiment is that the spaces left on the first and second memory cards 250 and 260 perfectly agree with each other on a sector or cluster basis. That is to say, as for the first and second memory cards 250 and 260 that are currently attached to the memory card adapter 200, every associated pair of empty sectors or clusters should have exactly the same address between the first and second memory cards 250 and 260, which is one of the requirements according to this preferred embodiment.

Hereinafter, it will be described, with an actual SD memory card taken as an example, in what procedure the spaces left in the first and second memory cards 250 and 260 are found in Step S330. Specifically, according to the SD Memory Card standard, the storage area of a memory card should be managed compliant with the FAT (file allocation tables) file system, which may be FAT 12, FAT 16 or FAT 32, or the ex FAT (extended FAT) file system, depending on the storage capacity of the given memory card.

According to the FAT file system, the storage area of a memory card is supposed to be managed on a cluster basis, and the space left is described on a cluster basis on the FAT table. That is why if the file system is the FAT file system, the spaces left in respective clusters of a memory card can be found by reference to the FAT table of the memory card.

On the other hand, according to the ex FAT file system, the space left is described on a cluster basis on an allocation bitmap. That is why if the file system is the ex FAT file system, the spaces left in respective clusters of a memory card can be found by reference to the allocation bitmap of the memory card.

In this case, the type of the file system that a memory card adopts has already been known during the processing step S320 of examining the format described above. Likewise, the address of the FAT table in the case of the FAT file system and the address of the allocation bitmap in the case of the ex FAT file system have also been known during the processing step S320 of examining the format described above.

As indicated by the arrows in FIG. 2, the control section 220 issues and sends a command by way of the first card interface 230, thereby retrieving either the FAT table or the allocation bitmap from the first memory card 250. In the same way, the control section 220 also issues and sends a command by way of the second card interface 240, thereby retrieving either the FAT table or the allocation bitmap from the second memory card 260, too.

The FAT tables or the allocation bitmaps that have been retrieved in this manner from the first and second memory cards 250 and 260 are compared to each other by the control section 220, thereby determining whether or not their empty clusters agree with each other perfectly. In this processing step S330, if it turns out that the empty clusters of the first and second memory cards 250 and 260 are exactly the same, then the control section 220 decides that there is no remaining space problem (OK) and the process advances to the next processing step S340. On the other hand, if any particular cluster is empty on one of the two memory cards but is not empty on the other, then the spaces left do not agree with each other, and therefore, the control section 220 decides that the simultaneous write operation cannot get done to end this testing process.

### Inspect Directories

In the next processing step S340, the control section 220 inspects the directories of the first and second memory cards 250 and 260 that are currently attached to the memory card adapter 200. In general, a directory is also called a “folder” and is a kind of management information generated by a file system. Hereinafter, it will be described how to inspect directories in an FAT file system and an ex FAT file system, for example.

In a directory, stored is a piece of management information called “directory entry”. There are several kinds of directory entries. A general directory entry represents the presence of a file and includes pieces of information about the name, size and date of generation of the file and the location of its top data. Also, the presence of the directory itself, as well as the presence of a file, is represented by the directory entry. A number of directory entries can be included in one directory, which corresponds to the fact that multiple files or folders can be included in one folder. Such folders included in one folder are sometimes called “sub-folders” and directories included in one directory are sometimes called “sub-directories”.

When a file is newly saved in a directory, a directory entry is generated in that directory. Conversely, when a file is deleted from a directory, its associated directory entry is erased. Nevertheless, that directory entry erased is just labeled as “erased” and remains as a candidate to be recycled when a directory entry is newly generated next time.

Thus, the inside of a directory is made up of directory entries, “erased” directory entries, and spaces left that can store directory entries.

One of the conditions for getting the simultaneous write operation done according to this preferred embodiment is that as a result of the inspection of this processing step S340, the directories of the first and second memory cards 250 and 260 and the spaces left in a directory should agree with each other.

In this case, if two directories agree with each other, then it means that a directory is present under the same name and at exactly the same address in both of the first and second memory cards 250 and 260. Also, if the spaces left in a directory agree with each other, then it means that every one of the directories that are present on the first and second memory cards 250 and 260 has the same spaces left inside of that directory in both of the first and second memory cards 250 and 260. That is to say, when a new file is stored in a directory, the address at which a directory entry is generated should be in either “empty” state or “erased” state in both of the first and second memory cards 250 and 260.

Hereinafter, it will be described, with an actual SD memory card taken as an example, in what procedure the directories are inspected in Step S340. According to both the FAT file system and ex FAT file system for SD memory cards, there is always a directory called a “root directory”. A predetermined directory can be referred to by tracing sub-directories from the root directory. The address of the root directory may sometimes be the top of a data area and may sometimes be described on the boot record of a file system. Thus, in this processing step S340 of inspecting the directories, the control section 220 compares the empty states for each directory by beginning with the root directory as a starting point.

In this case, not only the type of the file system that each memory card adopts but also the address of the root directory have already been known in the processing step S320 of examining the formats.

As indicated by the arrows in FIG. 2, the control section 220 issues and sends a command by way of the first card interface 230, thereby retrieving data of the root directory from the first memory card 250. In the same way, the control section 220 also issues and sends a command by way of the second card interface 240, thereby retrieving data of the root directory from the second memory card 260, too.

The data of the root directory that have been retrieved in this manner from the first and second memory cards 250 and 260 are compared to each other by the control section 220, thereby determining whether or not the spaces left in their root directory and the addresses of “erased” directory entries agree with each other perfectly between the first and second memory cards 250 and 260.

In this case, if there are some directory entries inside the root directory on one of the two memory cards but if the root directory of the other memory card either is empty or has “erased” directory entries, then the spaces left in the directory do not agree with each other. In that case, the control section 220 decides that the simultaneous write operation cannot get done (NG) to end this testing process.

On the other hand, if the spaces left in the root directory agree with each other between the first and second memory cards 250 and 260, then the control section 220 further compares the names and addresses of sub-directories, i.e., directories included in the root directory.

In this case, if the first and second memory cards 250 and 260 have sub-directories (sub-folders) under mutually different directory names or at mutually different sub-directory addresses, then their directory names or addresses do not agree with each other. In that case, the control section 220 decides that the simultaneous write operation cannot get done (NG) to end this testing process.

This decision is made for the following reasons. The information writing device 100 generates an AV file in a directory with a predetermined name. That is to say, based on the information that has been retrieved from a single memory card, a directory entry is generated in a predetermined space left inside a directory that has the predetermined name at a predetermined address. In this case, the same write operation is performed by the control section 220 on both of the first and second memory cards 250 and 260 that are currently attached to the memory card adapter 200. That is why on both of the first and second memory cards 250 and 260 that are attached to the memory card adapter 200, a directory with the same name should be present at the same address and the inside of that directory should have the same spaces left, too.

If the names and addresses of sub-directories agree with each other between the first and second memory cards 250 and 260, then the control section 220 further compares the spaces left in the sub-directories. This can be done in the same way as when the spaces left in the root directory are compared as described above. In this case, if there are some directory entries inside each of the sub-directories on one of the two memory cards but if the associated sub-directory of the other memory card either is empty or has “erased” directory entries, then the spaces left in the sub-directory do not agree with each other. In that case, the control section 220 decides that the simultaneous write operation cannot get done (NG) to end this testing process.

And if a sub-directory further includes a directory entry representing the presence of that sub-directory, then the same kind of comparison processing is carried out on every sub-directory.

As a result of this processing, in this processing step S340, the control section 220 compares the names and addresses of directories and the spaces left in the directories to each other with respect to every one of the directories that are present on the first and second memory cards 250 and 260. And if it turns out that everything agrees perfectly between the two memory cards, then the decision of this directory inspecting processing step S340 will be “OK”.

In this manner, the testing process including these processing steps S300 through S340 gets done. According to this preferred embodiment, these processing steps are carried out by the control section 220 in the memory card adapter 200.

If the decision of every one of the testing processing steps shown in FIG. 3 is OK, then the control section 220 in the memory card adapter 200 notifies the information writing device 100 that the memory card adapter 200 has now gotten ready to accept any command from the information writing device 100. Specifically, in that case, the control section 220 notifies the information writing device 100 by way of the host interface 210 that the memory card adapter 200 is ready to accept commands.

In that case, the control section 220 performs a control operation so as to show only the first memory card 250, not both of the first and second memory cards 250 and 260, to the information writing device 100. Then, it seems to the information writing device 100 that only one memory card has been inserted into the card interface 130 as in the conventional device.

In FIG. 1, when the memory card adapter 200 that has been inserted into the card interface 130 gets ready to accept commands, then the CPU 110 issues and sends either a read command or a status check command to the memory card adapter 200 attached by way of the card interface 130.

On receiving the read command from the information writing device 100, the control section 220 of the memory card adapter 200 conveys the read command to the first memory card 250 by way of the first card interface 230. Then, the first memory card 250 accepts the read command and returns the read data requested in response to the command. The read data is then transferred to the control section 220 by way of the first card interface 230 and then to the information writing device 100 by way of the host interface 210. In this manner, the information writing device 100 can obtain read data, which has been requested by sending the read command, from the memory card adapter 200.

As can be seen from this example, a read command is conveyed from the information writing device 100 to only a particular one of the first and second memory cards 250 and 260 that are currently attached to the memory card adapter 200 and read data is returned from only that particular memory card to the information writing device 100.

The same can be said about a memory card status check command. That is to say, just like the read command, the memory card status check command is also conveyed to only a particular one of the first and second memory cards 250 and 260 that are currently attached to the memory card adapter 200 and response is returned from only that particular memory card to the information writing device 100.

After having checked out the contents and status of the memory card adapter 200 connected, the information writing device 100 starts performing the operation of writing AV data. And when the information writing device 100 starts performing a write operation, the CPU 110 issues and sends either a write command or a memory card control command by way of the card interface 130 in order to write AV data.

On receiving the write command from the information writing device 100, the control section 220 of the memory card adapter 200 copies the write command and issues and sends the same write command to the first and second memory cards 250 and 260 that are currently attached to the memory card adapter 200. Specifically, the control section 220 conveys the write command to the first memory card 250 by way of the first card interface 230 and also conveys the same write command to the second memory card 260 by way of the second card interface 240 at the same time. As for the write data that has been come from the information writing device 100 next to the write command, the control section 220 also copies the write data and sends that write data to the first and second memory cards 250 and 260. On being notified by the first and second memory cards 250 and 260 that the write operation has been done successfully, the control section 220 responds to the information writing device 100 by way of the host interface 210 to notify the information writing device 100 that the write operation has been finished.

As described above, the write command and the write data that have been issued and sent by the information writing device 100 are copied inside the memory card adapter 200 and the same write command and the same write data are conveyed at the same time to the first and second memory cards 250 and 260 that are currently attached to the memory card adapter 200. Just like the write command, any other memory card control command is also conveyed to each of the first and second memory cards 250 and 260 that are currently attached to the memory card adapter 200.

As also described above, after having checked out the first and second memory cards 250 and 260 that have been attached to itself following the procedure of the flowchart shown in FIG. 3, the memory card adapter 200 allows the information writing device 100 to issue a command. If the command issued by the information writing device 100 is either a read command or a card status check command, the memory card adapter 200 conveys the command to only a particular one of the first and second memory cards 250 and 260 that are currently attached to itself and returns its response and read data to the information writing device 100. On the other hand, if the command issued by the information writing device 100 is either a write command or a card status control command, then the memory card adapter 200 copies that command and write data in itself and coveys the same command and the same write data to the first and second memory cards 250 and 260.

If the memory card adapter 200 of this preferred embodiment is connected to the information writing device 100 instead of the memory card 160, the memory card adapter 200 operates as described above so that AV data is written simultaneously on both of the first and second memory cards 250 and 260. Hereinafter, the procedure of this simultaneous write operation will be described.

First of all, the memory card adapter 200 is connected the information writing device 100. When connected to the information writing device 100, the internal circuits of the memory card adapter 200 are supplied with electric power and the testing process is carried out following the procedure of the flowchart shown in FIG. 3 during the loading process. If every decision made in the testing process is OK, the memory card adapter 200 gets ready to accept any command. And when the memory card adapter 200 connected gets ready to accept any command, the information writing device 100 issues a read command and a card status check command to check out the internal status of the memory card adapter 200. Under the control performed by the control section 220, the read command and the card status check command that have been issued by the information writing device 100 are conveyed to only the memory card 250 by way of the first card interface 230, not both of the first and second memory cards 250 and 260. And its response and read data are returned to the information writing device 100.

As a result, the information writing device 100 gets pieces of information about the internal status, directories and addresses of the spaces left of the memory card 250 from the memory card adapter 200. Based on these pieces of information, the information writing device 100 issues a write command to write AV data on those empty spaces specified by the addresses and also issues a write command to write the management information of its associated file system onto a predetermined address. These write commands have been generated based on the spaces left and directories of the memory card 250, and therefore, are right write commands for the memory card 250. Meanwhile, as for the other memory card 260, it has already been confirmed through the testing process during the loading process that the memory card 260 also has the same spaced left and the same directories as the memory card 250. That is why the write command to write the AV data onto the spaces left in the memory card 250 and the write command to write management information of its associated file system are right write commands for the other memory card 260, too.

These write commands are copied by the control section 220. And the same write command is issued to the first and second memory cards 250 and 260 at the same time and the write data is also copied and transferred to both of them at the same time. As a result, the same AV data is written simultaneously as a file on the first and second memory cards 250 and 260 that are currently attached to the memory card adapter 200. Although the information writing device 100 has no simultaneous write function by itself, the information writing device 100 can still write the same data on both of the first and second memory cards 250 and 260 at the same time without changing its own software or hardware at all just by connecting the memory card adapter 200 of this preferred embodiment to the device 100.

This memory card adapter 200 can be connected to not only the information writing device 100 but also a personal computer or any other external device in general. Thus, the memory card adapter 200 may also be designed so that predetermined numerical values, character strings, items to test, and items not to test may be specified with respect to the control section 220 by operating an external device such as a personal computer.

In that case, the value that has been set as a reference performance value for simultaneous writing in the processing step S310 of rating the memory card's performance, i.e., the predetermined performance value that is stored in advance in the memory card adapter 200, may be set or changed beforehand by using such an external device.

In the processing step S340 described above, the names, addresses and spaces left of the directories are supposed to be compared to each other for all directories that are present on the first and second memory cards 250 and 260. However, the names of the directories under test may be specified in advance using an external device. In that case, the processing step 340 of inspecting directories does not have to be carried out on every directory but may be carried out on only the directories under test. As a result, the testing process can get done in a shorter time.

Moreover, if the user specifies, by using an external device, which ones of those testing processing steps S300 through S340 need to be carried out and which ones may be skipped, then minimum required testing processing steps may be carried out with no time wasted.

### Embodiment 2

Hereinafter, a second specific preferred embodiment of the present invention will be described. According to the first preferred embodiment of the present invention described above, the simultaneous write function is provided just by connecting the memory card adapter 200 to the information writing device 100 without changing the software or hardware of the information writing device 100 at all. On the other hand, according to this second preferred embodiment, a simultaneous write operation can be performed with a memory card adapter by partially changing the control software of the information writing device. The following description of the second preferred embodiment will be focused on such a difference from the first preferred embodiment described above, and their common features will not be described all over again to avoid redundancies.

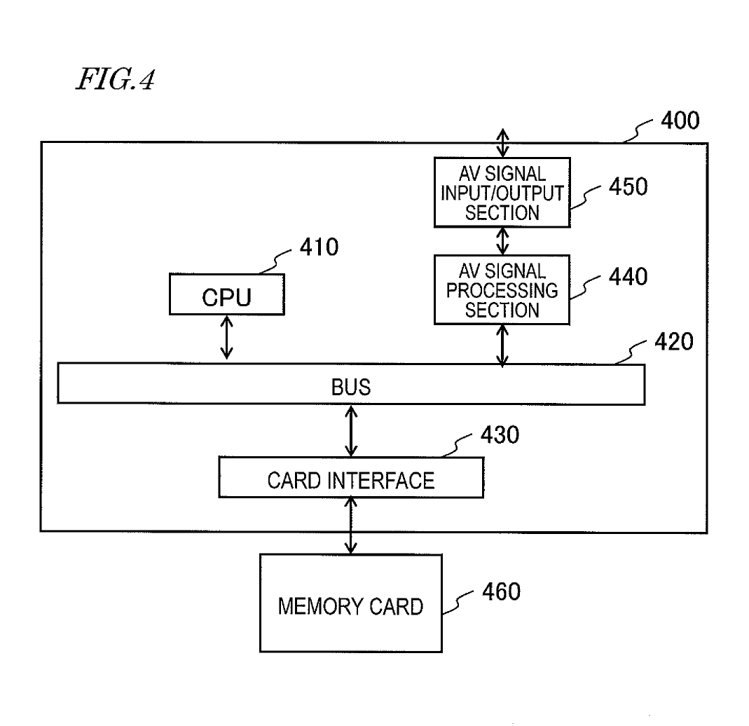

FIG. 4 is a block diagram illustrating a general configuration for an information writing device as a second specific preferred embodiment of the present invention. As shown in FIG. 4, the information writing device 400 of this preferred embodiment includes a CPU 410, a bus 420, a card interface 430, an AV signal processing section 440, and an AV signal input/output section 450. One memory card 460 can be inserted into this information writing device 400 at a time. As can be seen, the information writing device 400 of this preferred embodiment has the same hardware configuration as the information writing device 100 of the first preferred embodiment described above.

The respective components of the information writing device 400 of this preferred embodiment are identical with their counterparts of the information writing device 100 shown in FIG. 1, and description thereof will be omitted herein. Nevertheless, according to this preferred embodiment, the software (program) for operating the CPU 410 is supposed to be changed afterward. That is to say, the software for operating the CPU 410 is supposed to be modifiable so that the memory card adapter can be connected to, and operated properly in, the information writing device 400.

The scheme adopted by this information writing device 400 to write video, audio or any other kind of information on a memory card as a file is the same as what is used by the information writing device 100 of the first preferred embodiment described above, and description thereof will also be omitted herein.

Just like the information writing device 100 of the first preferred embodiment described above, the internal hardware of this information writing device 400 has transfer capability that is high enough to pass only one stream of AV data at a time, and does not have transfer capability that is high enough to pass multiple streams of AV data at a time to get simultaneous writing done. That is why according to this preferred embodiment, the simultaneous write operation cannot get done, either, unless the memory card adapter is used.

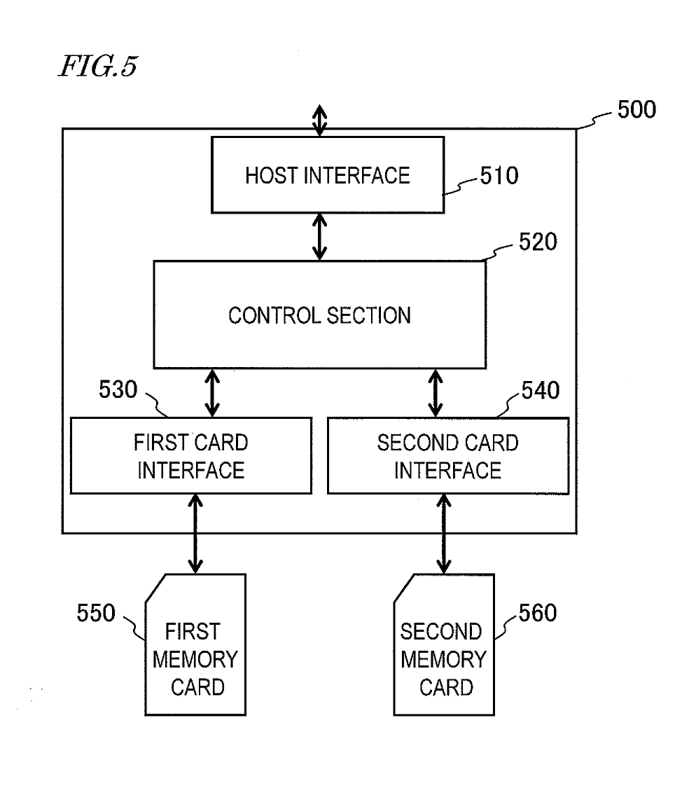

FIG. 5 is a block diagram illustrating a configuration for the memory card adapter of this preferred embodiment. As shown in FIG. 5, the memory card adapter 500 includes a host interface 510, a control section 520 and first and second card interfaces 530 and 540. Two memory cards can be attached to this memory card adapter 500. The first and second memory cards 550 and 560 are attached to this memory card adapter 500. The external dimensions of the memory card adapter 500 and the first and second memory cards 550 and 560 are the same as those of the memory card adapter 200 shown in FIG. 2. That is to say, it is possible to insert this memory card adapter 500, instead of the memory card 460, into the information writing device 400.

However, unlike the memory card adapter 200 of the first preferred embodiment described above, the various processing steps that are performed by the control section 220 in the memory card adapter 200 are carried out by the information writing device 400 according to this preferred embodiment. This is a major difference between the memory card adapter 200 of the first preferred embodiment and the memory card adapter 500 of this second preferred embodiment. Thus, the following description of the operations of the information writing device 400 and the memory card adapter 500 will be focused on this respect and common features between the first and second preferred embodiments will not be described all over again to avoid redundancies.

When the memory card adapter 500 is inserted into the information writing device 400, the memory card adapter 500 is connected to the card interface 430 of the information writing device 400 by way of the host interface 510. As a result of this connection, power is supplied to the memory card adapter 500 and the control section 520 starts to operate.

The control section 520 reveals the presence of the first and second memory cards 550 and 560 to the information writing device 400 by way of the first and second card interfaces 530 and 540, respectively. That is to say, for the information writing device 400, the first and second memory cards 550 and 560 are now recognizable through the memory card adapter 500. Thus, according to this preferred embodiment, the CPU 410 of the information writing device 400 sees if the first and second memory cards 550 and 560 satisfy the condition of simultaneous writing. Hereinafter, it will be described with reference to a flowchart how to examine whether the condition of simultaneous writing is satisfied or not.

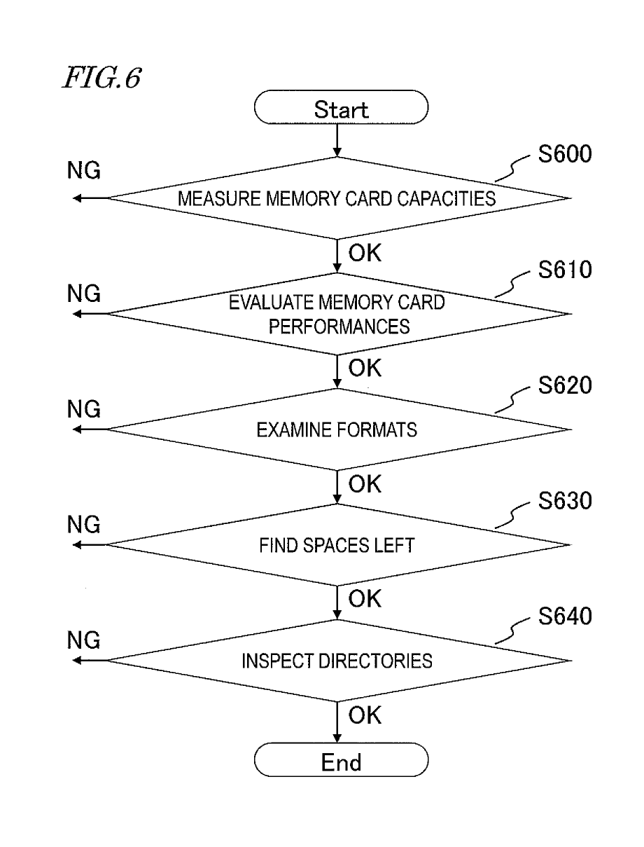

FIG. 6 is a flowchart showing the procedure of a card testing method according to this preferred embodiment. As shown in FIG. 6, the memory cards have their storage capacities measured in Step S600, have their card performances evaluated in Step S610, have their formats examined in Step S620, have their spaces left found in Step S630 and then have their directories inspected in Step S640. According to this preferred embodiment, the respective testing processing steps shown in FIG. 6 are carried out by the CPU 410 of the information writing device 400.

Hereinafter, the respective processing steps of the card testing method shown in FIG. 6 will be described in detail one by one.

### Measure Storage Capacities

First of all, in Step S600, the CPU 410 measures the overall storage capacities of the first and second memory cards 550 and 560 that are currently attached to the memory card adapter 500. As shown in FIG. 4, the CPU 410 issues and sends a command to the first and second memory cards 550 and 560 in the memory card adapter 500, which has been inserted instead of the memory card 460, by way of the card interface 430, thereby getting numerical values representing the overall storage capacities of the two memory cards.

At this point in time, a command is sent from the information writing device 400 to the memory card adapter 500 by way of the host interface 510. If the command that has come from the information writing device 400 has been issued with respect to the first memory card 550, the control section 520 conveys that command to the first memory card 550 by way of the first card interface 530 and returns its response to the information writing device 400. On the other hand, if the command that has come from the information writing device 400 has been issued with respect to the second memory card 560, the control section 520 conveys that command to the second memory card 550 by way of the second card interface 540 and returns its response to the information writing device 400.

Then, the CPU 410 compares the respective overall storage capacities of the first and second memory cards 550 and 560 that are currently attached to the memory card adapter 500. If the CPU 410 has found, as a result of the comparison, that the first and second memory cards 550 and 560 have the same storage capacity, then the CPU 410 decides that it is OK and the process advances to the next processing step S610. On the other hand, if it turns out that the first and second memory cards 550 and 560 have different overall storage capacities, then the CPU 410 decides that the simultaneous write operation cannot get done (NG) to end this testing process.

### Evaluate Performances

In the next processing step S610, the CPU 410 evaluates the performances of the memory cards. Since this testing processing step is the same as the processing step S310 of the first preferred embodiment described above, description thereof will be omitted herein.

According to this preferred embodiment, however, it is not the control section 520 but the CPU 410 that is in charge of this performance evaluation by issuing commands, which is a major difference from the first preferred embodiment described above. Specifically, for that purpose, the CPU 410 gets the respective performance values of the first and second memory cards 550 and 560 that are currently attached to the memory card adapter 500. If their performance values both turn out to be equal to or greater than a minimum required performance value to get the simultaneous writing done, the CPU 410 decides that there is no performance value problem (OK) and the process advances to the next processing step S620. However, if the performance value(s) of one or both of the first and second memory cards 550 and 560 turn(s) out to be less than the minimum required performance value, the CPU 410 decides that the simultaneous write operation cannot get done (NG) to end this testing process.

### Examine Formats

In the next processing step S620, the CPU 410 examines the formats of the first and second memory cards 550 and 560 that are currently attached to the memory card adapter 500. Since this format examining processing step is the same as the processing step S320 of the first preferred embodiment described above, description thereof will be omitted herein.

According to this preferred embodiment, however, it is not the control section 520 but the CPU 410 that is in charge of this format examination. Specifically, in this processing step S620, the CPU 410 retrieves data from the first and second memory cards 550 and 560 that are currently attached to the memory card adapter 500 and examines whether or not the format of each of these memory cards is compliant with a predetermined standard. If the format of at least one of the first and second memory cards 550 and 560 fails to be compliant with that standard or if the file systems of these two memory cards have different parameters, then the CPU 410 decides that the simultaneous write operation cannot get done (NG) to end this testing process.

### Find Spaces Left

In the next processing step S630, the CPU 410 checks out the spaces left in the first and second memory cards 550 and 560 that are currently attached to the memory card adapter 500. Since this space finding processing step is the same as the processing step S330 of the first preferred embodiment described above, description thereof will be omitted herein.

According to this preferred embodiment, however, it is not the control section 520 but the CPU 410 that is in charge of this space finding processing step. Specifically, in Step S630, the CPU 410 retrieves the management information of the file system from the first and second memory cards 550 and 560 that are currently attached to the memory card adapter 500, thereby examining whether or not the spaces left (i.e., empty clusters) agree with each other between the two memory cards. If it turns out that the empty clusters of the first and second memory cards 550 and 560 are exactly the same, then the CPU 410 decides that it is OK and the process advances to the next processing step S640. On the other hand, if any particular cluster is empty on one of the two memory cards but is not empty on the other, then the spaces left do not agree with each other, and therefore, the CPU 410 decides that the simultaneous write operation cannot get done (NG) to end this testing process.

### Inspect Directories

In the next processing step S640, the CPU 410 inspects the directories of the first and second memory cards 550 and 560 that are currently attached to the memory card adapter 500. Since this directory inspecting processing step is the same as the processing step S340 of the first preferred embodiment described above, description thereof will be omitted herein.

According to this preferred embodiment, however, it is not the control section 520 but the CPU 410 that is in charge of this directory inspecting processing step. In this processing step 640, the CPU 410 performs the inspecting processing step by retrieving directory information from the first and second memory cards 550 and 560 that are currently attached to the memory card adapter 500.

Particularly, according to this preferred embodiment, the CPU 410 can reduce the number of directories to inspect. The reason is that as the CPU 410 that performs this inspecting processing step is one of the components of the information writing device 400, the information writing device 400 should know in advance the name of the directory to write an AV file on. That is why in this processing step S640, there is no need for the CPU 410 to compare and inspect all directories that are present on the first and second memory cards 550 and 560. Instead, the CPU 410 has only to inspect only the directories that the information writing device 400 will use to write AV files on and their related directories. Consequently, according to this preferred embodiment, the time it takes to inspect the directories can be shortened.

In this manner, the testing process including these processing steps S600 through S640 shown in FIG. 6 gets done. According to this preferred embodiment, these processing steps are carried out by the CPU 410 in the information writing device 400, not the control section 520 in the memory card adapter 500.

If the decision of every one of the testing processing steps shown in FIG. 6 is OK, then the CPU 410 issues an instruction to change the modes of operation of the control section 520 in the memory card adapter 500.

In the processing of this preferred embodiment described above, the memory card adapter 500 shows both of the first and second memory cards 550 and 560 to the information writing device 400. Such a mode of operation will be referred to herein as a “multi-card mode”. If the memory card adapter 500 is operating in the multi-card mode, the information writing device 400 can issue commands independently of each other with respect to the first and second memory cards 550 and 560 that are currently attached to the memory card adapter 500.

On the other hand, according to the first preferred embodiment of the present invention described above, the memory card adapter 200 shows only one memory card to the information writing device 100. Such a mode of operation will be referred to herein as a “single-card mode”. In a situation where the memory card adapter is operating in the single-card mode, if the information writing device issues a read command or a card status check command, the memory card adapter conveys that command to only one of the multiple memory cards and returns its response and read data to the information writing device. On the other hand, if the information writing device issues a write command or a card status control command, the memory card adapter copies the command and write data inside and conveys the same command and same write data to all of the multiple memory cards.

In accordance with the instruction to change the modes of operation that has been given by the information writing device 400, the control section 520 of the memory card adapter 500 changes the modes of operation of the memory card adapter 500 from the multi-card mode into the single-card mode. From this point in time on, the information writing device 400 will write AV data on the memory card adapter 500 that operates in the single-card mode, as in the write operation of the first preferred embodiment described above. That is to say, the write command issued by the information writing device 400 is copied inside of the memory card adapter 500 and then conveyed to the first and second memory cards 550 and 560. As a result, the simultaneous write operation gets done.

Even though the information writing device 400 does not have the simultaneous writing function by itself as described above, the information writing device 400 can still write the same data on both of the first and second memory cards 550 and 560 at the same time by connecting the memory card adapter 500 of this preferred embodiment to the device 400 and by modifying the software for the CPU 410 of the information writing device 400.

In the preferred embodiment described above, the modes of operation of the memory card adapter 500 are supposed to be changed from the multi-card mode into the single-card mode. However, this is just an example of the present invention and this method does not always have to be adopted. Instead, the simultaneous write operation can also be performed without changing the modes of operation from the multi-card mode. In that case, the first and second memory cards 550 and 560 can be kept recognizable for the information writing device 400 through the memory card adapter 500. The information writing device 400 performs the operation of writing an AV file on only a particular memory card. To do that, the information writing device 400 adds a copy flag to either a write command or a card status control command before issuing that command with respect to the memory card adapter 500. If the command that has been received from the information writing device 400 has a copy flag, the memory card adapter 500 copies that command and conveys the command to the first and second memory cards 550 and 560 that are currently attached to the memory card adapter 500. A write operation can also be performed on the first and second memory cards 550 and 560 simultaneously in this manner.

Optionally, instead of adding such a copy flag to the command, a special copy command, which is different from normal commands, may be separately provided. If the command that has been received from the information writing device 400 turns out to be such a copy command, the memory card adapter 500 copies that command and conveys the command simultaneously to the first and second memory cards 550 and 560 that are currently attached to the memory card adapter 500. In this manner, a write operation can also be performed on the first and second memory cards 550 and 560 simultaneously.

As for specific examples of the memory card adapters of the first and second preferred embodiments of the present invention described above and the two memory cards to be attached to the memory card adapter, the following combinations may be adopted:
1. a memory card adapter compliant with the PC Card standard and memory cards compliant with the SD Memory Card standard;
2. a memory card adapter compliant with the Express Card standard and memory cards compliant with the SD Memory Card standard; and
3. a memory card adapter compliant with the CompactFlash standard and memory cards compliant with the SD Memory Card standard.

In this case, the “SD Memory Card standard” covers mini SD memory cards, micro SD memory cards, SDHC cards and SDXC cards as well. The “PC Card standard” and the “Express Card standard” are memory card standards that were established by a standardization organization called PCMCIA (Personal Computer Memory Card International Association). And the “CompactFlash standard” is a memory card standard that was set up by CFA (CompactFlash Association).

However, the memory card standards to adopt do not always have to be one of these combinations. Alternatively, the memory card adapters of the first and second preferred embodiments of the present invention described above may also be designed so as to be compliant with one memory card standard that defines a certain external dimension and another memory card standard that defines a smaller external dimension. That is to say, in that case, the memory card adapter may be designed compliant with the memory card standard that defines the larger external dimension and memory cards, which are compliant with the standard that defines the smaller external dimension, may be attached to the memory card adapter.

Meanwhile, not every information writing device uses memory cards but some information writing devices may use a USB memory or a USB hard disk as an external storage medium to attach. In that case, the card interface 130 of the information writing device 100 or the card interface 430 of the information writing device 400 may be a USB interface. On the other hand, if the host interface 210 of the memory card adapter 200 or the host interface 510 of the memory card adapter 500 is a USB interface, then a memory card adapter that can be inserted into a USB interface is obtained. By connecting such a memory card adapter to the information writing device, a write operation can be performed on multiple memory cards simultaneously.

According to the first and second preferred embodiments of the present invention described above, before the write operation is started, the processing of examining the logical formats of the two memory cards is supposed to be performed. Specifically, such logical format examining processing corresponds to the examining processing steps S320, S330 and S340 shown in FIG. 3 and the examining processing steps S620, S630 and S640 shown in FIG. 6. If the information writing device is supposed to always format two memory cards to use before starting a write operation, then the file system management information of the two memory cards will define the same space left, and therefore, there is no need to examine their logical formats. That is why if the memory cards have passed either the examining processing steps S300 and S310 shown in FIG. 3 or the examining processing steps S600 and S610 shown in FIG. 6, then the rest of the examination may be omitted and the write operation may be started after the two memory cards have been formatted. Even so, the same effects can also be achieved.

In the first and second preferred embodiments of the present invention described above, two memory cards are supposed to be attached to the memory card adapter. However, three or more memory cards may also be attached to the memory card adapter. In that case, the memory card adapter can perform the operation of writing AV data simultaneously on at least two of the multiple memory cards attached.

### Embodiment 3

Hereinafter, a third specific preferred embodiment of the present invention will be described. According to this preferred embodiment, the simultaneous write operation can be performed on multiple storage media that have mutually different specifications, card storage capacities, partition positions, sizes and file system types, which is a major difference from the first and second preferred embodiments of the present invention described above. Thus, the following description of this third preferred embodiment of the present invention will be focused on that difference and their common features will not be described all over again to avoid redundancies.

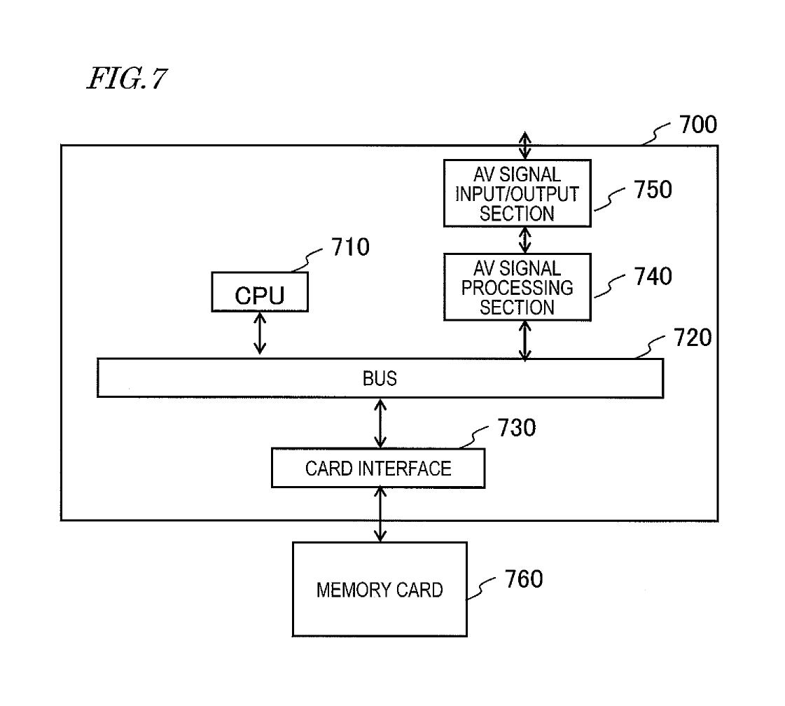

FIG. 7 is a block diagram illustrating a general configuration for an information writing device 700 as a third preferred embodiment of the present invention. As shown in FIG. 7, the information writing device 700 includes a CPU 710, a bus 720, a card interface 730, an AV signal processing section 740, and an AV signal input/output section 750. One memory card 760 can be inserted into this information writing device 700 at a time.

The respective components of the information writing device 700 of this preferred embodiment are identical with their counterparts of the information writing device 100 shown in FIG. 1, and description thereof will be omitted herein. The scheme adopted by this information writing device 700 to write video, audio or any other kind of information on a memory card as a file is the same as what is used by the information writing device 100 of the first preferred embodiment described above, and description thereof will also be omitted herein. Nevertheless, according to this preferred embodiment, the software (program) for operating the CPU 710 can be changed afterward as in the second preferred embodiment described above. That is to say, the software for operating the CPU 110 is modified in order to perform a simultaneous write operation on multiple memory cards by connecting the memory card adapter to the information writing device 700.

Just like the information writing device 100 of the first preferred embodiment described above, the internal hardware of this information writing device 700 has transfer capability that is high enough to pass only one stream of AV data at a time, and does not have transfer capability that is high enough to pass multiple streams of AV data at a time. That is why according to this preferred embodiment, the simultaneous write operation cannot get done, either, unless the memory card adapter is used.

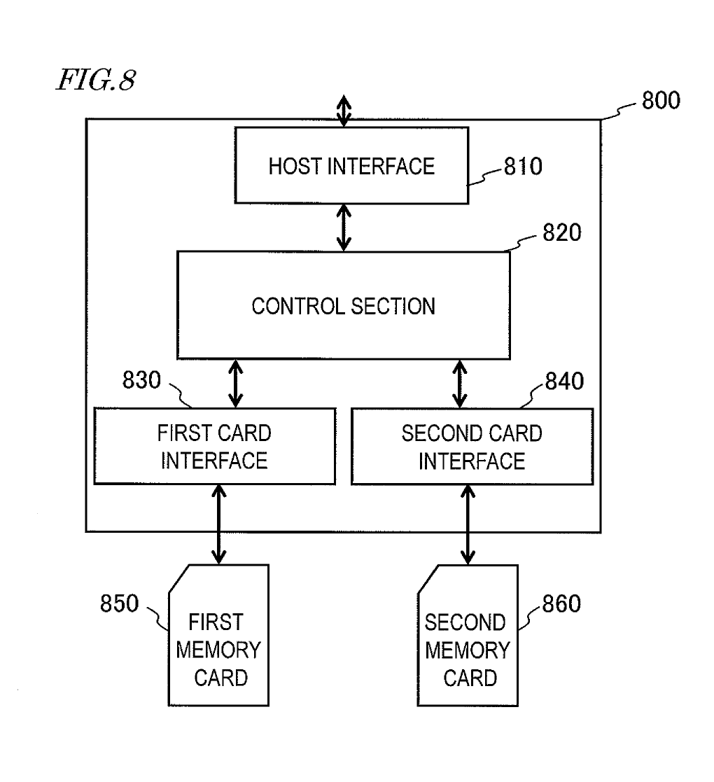

FIG. 8 is a block diagram illustrating a configuration for the memory card adapter 800 of this preferred embodiment. As shown in FIG. 8, the memory card adapter 800 includes a host interface 810, a control section 820 and first and second card interfaces 830 and 840. The physical structure of the memory card adapter 800 of this preferred embodiment is the same as that of the memory card adapters of the first and second preferred embodiments described above.

The external dimensions and the card interfaces of the memory card adapter 800 are the same as those of the memory card 760. That is to say, it is possible to insert this memory card adapter 800, instead of the memory card 760, into the information writing device 700. The host interface 810 can be connected both mechanically and electrically to the card interface 730 of the information writing device 700. The control section 820 performs an overall control on the entire memory card adapter 800. The first and second card interfaces 830 and 840 can be mechanically and electrically connected to the first and second memory cards 850 and 860, respectively, and hold the cards in a readily removable position. Each of the first and second memory cards 850 and 860 is designed not to protrude from the outer surface of the memory card adapter 800 when inserted into the memory card adapter 800. That is why even when the first and second memory cards 850 and 860 are attached to the memory card adapter 800, the memory card adapter 800 can still be connected to the information writing device 100.

And when the memory card adapter 800 is inserted into the information writing device 700, the memory card adapter 800 gets connected to the card interface 830 of the information writing device 700 by way of the host interface 810. As a result of this connection, power is supplied to the memory card adapter 800 and the control section 820 starts to operate.

The control section 820 reveals the presence of the first and second memory cards 850 and 860 to the information writing device 700 by way of the first and second card interfaces 830 and 840, respectively. That is to say, for the information writing device 700, the first and second memory cards 850 and 860 are now recognizable through the memory card adapter 800. Thus, according to this preferred embodiment, the CPU 710 of the information writing device 700 sees if the first and second memory cards 850 and 860 satisfy the condition of simultaneous writing.

The information writing system of this preferred embodiment (including the information writing device 700 and the card interface 800) is basically designed to perform simultaneous writing on the first and second memory cards 850 and 860, of which the specifications, card storage capacities, partition positions, sizes and the types of file systems are different from each other. To achieve this purpose, the addresses of the data areas in the first and second memory cards 850 and 860 are set by the control section 820. In writing AV data with a big data size, the control section 820 copies the data that the information writing device 700 is going to write on a single memory card, and writes that copied data, along with the address of the data area that has been defined, on the first and second memory cards 850 and 860 simultaneously. Hereinafter, the principle of the simultaneous write operation of this preferred embodiment will be described in detail with reference to the accompanying drawings.

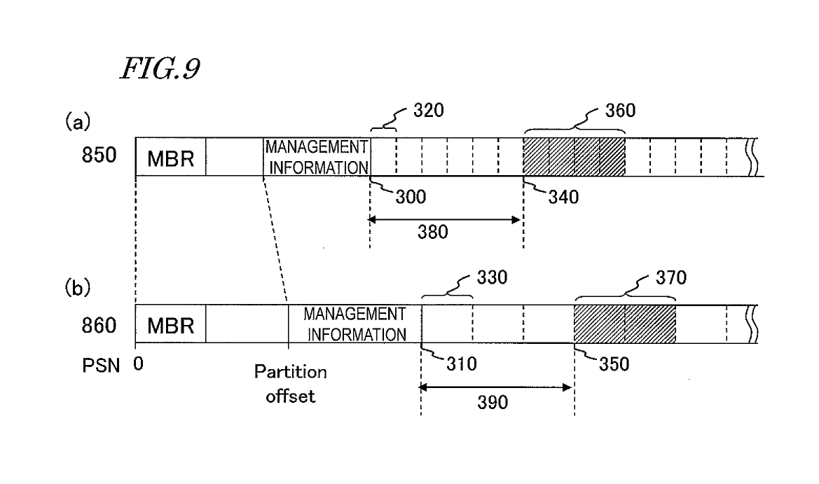

FIG. 9 is a block diagram illustrating exemplary arrangements of data in the first and second memory cards 850 and 860 of this preferred embodiment. Specifically, portion (a) of FIG. 9 illustrates the arrangement of data in the first memory card 850, while portion (b) of FIG. 9 illustrates the arrangement of data in the second memory card 860. The addresses 300 and 310 are the start addresses of the respective data areas of the first and second memory cards 850 and 860. The areas 320 and 330 are respectively used as the data management blocks of the first and second memory cards 850 and 860. The addresses 340 and 350 are the start addresses of the respective areas of the first and second memory cards 850 and 860 where file data is stored. And the areas 360 and 370 are respectively those areas of the first and second memory cards 850 and 860 where the file data is stored.

In general, the start address of a data area is described in the management information of a file system. File data is written, and its arrangement is managed, on a data management block basis. For example, according to the FAT (file allocation tables) file system, file data is written on the basis of a data management block called “cluster”. In the management information called “FAT table”, included are various pieces of information about the positions and order of clusters where file data is stored. Also, another piece of information called “directory entry” includes a file name, the date of generation, a file attribute, a file size, a start cluster and so on. The data area is located behind the FAT table area. Based on the FAT table size and the reserved area size that are included in a piece of information called “partition boot record”, the start address of the data area can be calculated.

In the example illustrated in FIG. 9, the data area start addresses 300 and 310 of the first and second memory cards 850 and 860 are different from each other. Also, one data management block 320 is only a half the size of one data management block 330. Meanwhile, the start addresses 340 and 350 of the respective areas where the file data is stored are also different from each other. However, their offsets 380 and 390 from the respective tops of their data areas correspond to six clusters and three clusters, respectively. And if each of these offsets is multiplied by the size of its data management block, the product will be the same. Likewise, the sizes of the areas 360 and 370 where their file data is stored correspond to four clusters and two clusters, respectively. And if each of these sizes is multiplied by the size of its data management block, it can be seen that the first and second memory cards 850 and 860 use the areas of the same size.

That is why if the size of one data management block of one of two memory cards is an integral number of times as large as that of one data management block of the other memory card as in the example illustrated in FIG. 9, data management blocks, of which the offsets from the top of the data area are equal to each other, can be detected.

For that reason, the CPU 710 sets the respective data area start addresses 300 and 310 of the two memory cards in advance in the control section 820. In performing a simultaneous write operation, the CPU 710 specifies an area that begins with the data area start address and sends a write command to the control section 820. In response, the control section 820 adds the data area addresses 300 and 310 of the two memory cards that have been set in advance to the addresses of those areas specified, thereby determining the addresses of the areas where data is going to be written. Then, the control section 820 copies that data and issues a write command with respect to the first and second memory cards 850 and 860. By performing such processing, a simultaneous write operation can be performed. In the following description, such a mode of operation of the control section 820 in which a simultaneous write operation is performed by adding the data area start address will be referred to herein as a “multi-card mode”, while another mode of operation of the control section 820 in which each of the two memory cards is accessed independently of each other will be referred to herein as a “single-card mode”.

Thus, to get the simultaneous write operation done, the common space left in the first and second memory cards 850 and 860 should be found.

In the information writing system of this preferred embodiment, the first and second memory cards 850 and 860 are used so as to be readily attachable and removable at any time. That is why it is indefinite what kind of memory card will be attached in what status of use. Consequently, to get the simultaneous write operation done, the processing of checking out the specifications and the statuses of the storage media and finding a common space left should be carried out.

After having confirmed that the first and second memory cards 850 and 860 are both connected and accessible, the control section 820 sees if the first and second memory cards 850 and 860 satisfy the condition of simultaneous writing. Hereinafter, it will be described with reference to a flowchart how to examine whether the condition of simultaneous writing is satisfied or not.

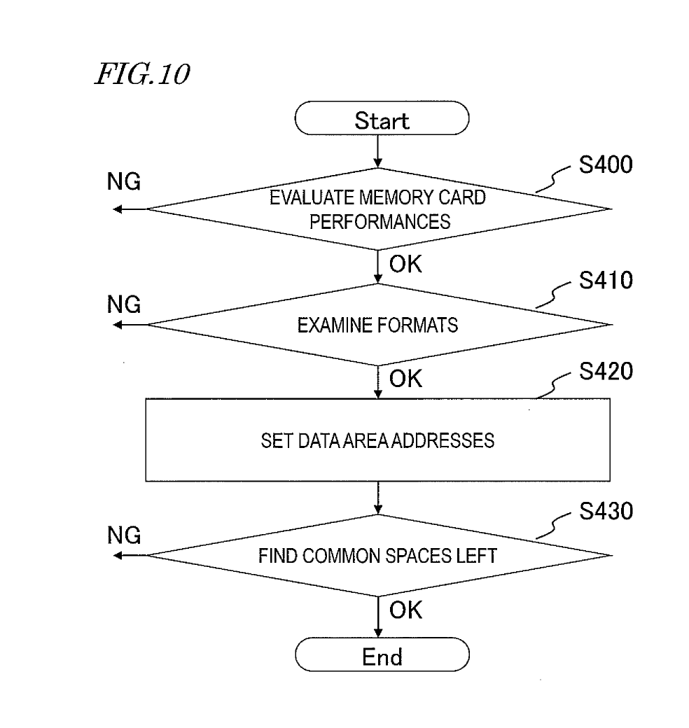

FIG. 10 is a flowchart showing the procedure of a memory card testing method according to this preferred embodiment. As shown in FIG. 10, the first and second memory cards 850 and 860 have their card performances evaluated in Step S400, have their formats examined in Step S410, have the address of their data area (where data is going to be written) set in Step S420, and have their common space left found in Step S430.

Hereinafter, the respective processing steps of the card testing method shown in the flowchart of FIG. 10 will be described in detail one by one.

### Evaluate Performances

In the first processing step S400, the CPU 710 evaluates the performances of the first and second memory cards 850 and 860 that are currently attached to the memory card adapter 800. Since this processing step is the same as the processing step S310 of the first preferred embodiment described above, description thereof will be omitted herein. According to this preferred embodiment, however, it is not the control section 820 but the CPU 710 that is in charge of this performance evaluation by issuing commands, as in the second preferred embodiment described above. Specifically, for that purpose, the CPU 710 gets the respective performance values of the first and second memory cards 850 and 860 that are currently attached to the memory card adapter 800. If their performance values both turn out to be equal to or greater than a minimum required performance value to get the simultaneous writing done, the CPU 710 decides that there is no performance value problem (OK) and the process advances to the next processing step S410. However, if the performance value(s) of one or both of the first and second memory cards 850 and 860 turn(s) out to be less than the minimum required performance value, the CPU 710 decides that the simultaneous write operation cannot get done (NG) to end this testing process.

### Examine Formats

In the next processing step S410, the CPU 710 examines the formats of the first and second memory cards 850 and 860 that are currently attached to the memory card adapter 800. Since this format examining processing step is the same as the processing step S320 of the first preferred embodiment described above, a detailed description thereof will be omitted herein. According to this preferred embodiment, however, it is not the control section 820 but the CPU 710 that is in charge of this format examination, as in the second preferred embodiment described above.

If the format of at least one of the first and second memory cards 850 and 860 fails to be compliant with the standard or has different file system parameters from the other memory card, then the CPU 710 decides that the simultaneous write operation cannot get done (NG) to end this testing process.

### Set Data Area Addresses

In the processing step S420, the start addresses of the data areas are set. The data area start addresses are calculated based on the file system parameters that have been obtained in the previous processing step S410 described above. The CPU 710 sends a data area set command to the memory card adapter 800, thereby setting the data area start addresses of the first and second memory cards 850 and 860.

### Check Cards for Spaces Left

Next, in the processing step S430, the CPU 710 checks out the first and second memory cards 850 and 860 that are currently attached to the memory card adapter 800 to see if they have any common spaces left. One of the conditions for getting the simultaneous write operation done according to this preferred embodiment is to find a common space left in the first and second memory cards 850 and 860. That is to say, empty blocks, of which the offsets as measured from the top addresses of the data areas are equal to each other, need to be detected.

Hereinafter, it will be described, with an actual SD memory card taken as an example, in what procedure the common space left in the first and second memory cards 850 and 860 is found in Step S430. As described above, according to the SD Memory Card standard, the storage area of a memory card should be managed compliant with the FAT file system, which may be FAT 12, FAT 16 or FAT 32, or the ex FAT (extended FAT) file system, depending on the storage capacity of the given memory card.

According to the FAT file system, the storage area of a memory card is supposed to be managed on a cluster basis, and the space left is described on a cluster basis on the FAT table. That is why if the file system is the FAT file system, the spaces left in respective clusters from the beginning of the data area of a memory card can be found by reference to the FAT table of the memory card.

On the other hand, according to the ex FAT file system, the space left is described on a cluster basis on an allocation bitmap. That is why if the file system is the ex FAT file system, the spaces left in respective clusters from the beginning of the data area of a memory card can be found by reference to the allocation bitmap of the memory card.

In this case, the type of the file system that a memory card adopts has already been known during the processing step S410 of examining the format described above. Likewise, the address of the FAT table in the case of the FAT file system, the address of the allocation bitmap in the case of the ex FAT file system and the cluster sizes have also been known during the processing step S410 of examining the format described above.

At this point in time, the CPU 710 sees if the respective cluster sizes of the first and second memory cards 850 and 860 satisfy a multiple-divisor relation. Suppose a situation where the first memory card 850 has been formatted in the FAT 32 and has a cluster size of 32 KB, while the second memory card 860 has been formatted in the ex FAT and has a cluster size of 128 KB. In that case, the cluster size of the second memory card 860 is four times as large as that of the first memory card 850. Consequently, the CPU 710 decides that there is no problem as far as the cluster size is concerned. On the other hand, if the respective cluster sizes of the two memory cards 850 and 860 fail to satisfy the multiple-divisor relation, then the CPU 710 decides that the simultaneous write operation cannot get done (NG) to end this testing process.

If the respective cluster sizes of the first and second memory cards 850 and 860 satisfy the multiple-divisor relation, the CPU 710 retrieves their FAT tables or allocation bitmaps from the first and second memory cards 850 and 860 and scans their clusters sequentially from the top for an empty cluster. Supposing the first memory card 850 has a cluster size of 32 KB as in this example, four clusters of the first memory card 850 have the same size as one cluster of the second memory card 860 (that has a size of 128 KB). That is why the first memory card 850 is checked on a four cluster basis, the second memory card 860 is checked on a cluster basis, and their common empty cluster is counted as their common space left. The CPU 710 performs this processing until the end of either the FAT tables or allocation bitmaps is reached in the first and second memory cards 850 and 860.

In recent years, as the storage capacities of flash memories have been further increased, a write operation is more and more often performed on the basis of a block, which is greater than a cluster. Such a block is called an AU (allocation unit). In that case, a continuous space left corresponding to the size of an AU needs to be found. For example, if an AU has a size of 4 MB and if one cluster has a size of 32 KB, a continuous space left needs to cover 128 clusters. On the other hand, if one cluster has a size of 128 KB, then a continuous space left needs to cover 32 clusters. Even so, the common space left can also be found just as described above. Specifically, the CPU 710 checks the first and second memory cards 850 and 860 on a 128 cluster basis and on a 32 cluster basis, respectively, and counts their common empty cluster as their common space left. The CPU 710 performs this processing until the end of either the FAT tables or allocation bitmaps is reached in the first and second memory cards 850 and 860.

If no common spaces left have been found as a result of the common space left finding processing described above, then the CPU 710 decides that the simultaneous write operation cannot get done (NG) to end this testing process. On the other hand, if any common space left has been found, the CPU 710 decides that the simultaneous write operation can get done (OK).

In this manner, the testing process including these processing steps S400 through S430 shown in FIG. 10 gets done. According to this preferred embodiment, these processing steps are carried out by the CPU 710 in the information writing device 700. If the decision of every one of the testing processing steps shown in FIG. 10 is OK, then the simultaneous write operation can be accepted.

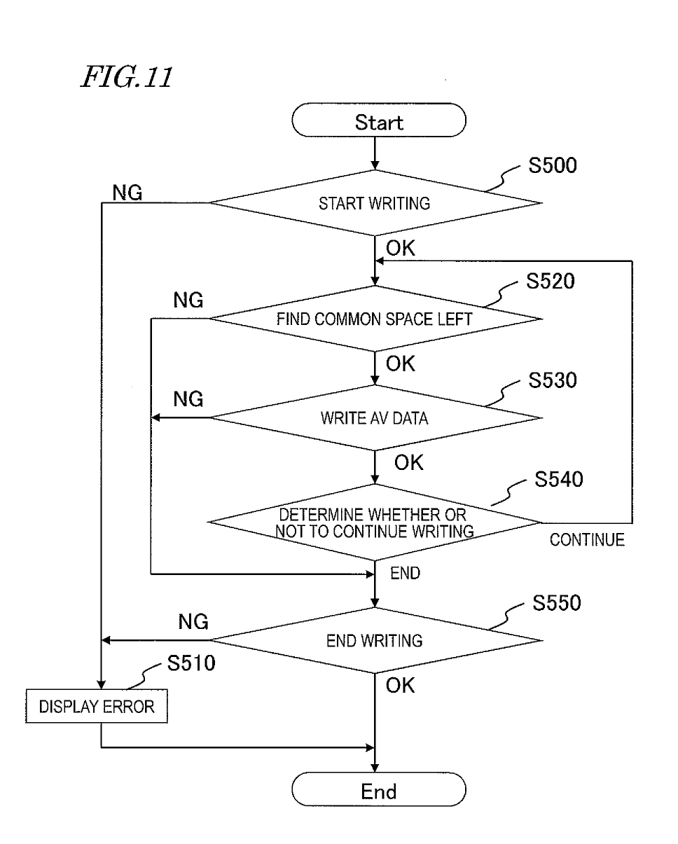

FIG. 11 is a flowchart showing the procedure of an AV data writing method according to this preferred embodiment. As shown in FIG. 11, this procedure includes the step S500 of starting writing AV data, the step S510 of displaying an error if any, the step S520 of finding a common space left, as an area where data is going to be written, in the first and second memory cards 850 and 860, the step S530 of writing the AV data, the step S540 of determining whether the write operation should be continued or not, and the step S550 of ending the AV data writing operation.

Hereinafter, the respective processing steps of the AV data writing method shown in the flowchart of FIG. 11 will be described in detail one by one.

### Start Writing

In the first processing step S500, as a write operation is started, an AV file is generated in a predetermined directory.

One of the conditions for getting the simultaneous write operation done according to this preferred embodiment is that no file that has the same name as the AV file to make be present in a predetermined directory of the first and second memory cards 850 and 860. Thus, the CPU 710 retrieves the predetermined directory from each of the first and second memory cards 850 and 860 in the multi-card mode and examines whether or not there is any file that has the same name as the AV file to make in that directory. If the answer is YES, the CPU 710 decides that the simultaneous write operation cannot get done (NG).

On the other hand, if there is no file that has the same name, then CPU 710 decides that the simultaneous write operation could get done (OK) and writes a directory entry in the predetermined directory of each of the first and second memory cards 850 and 860 in the multi-card mode. Although the directory entry does include a file name and the date of generation, the file size and the location of the top data have not been determined yet and therefore set to be zero.

If the decision made in Step S500 is NG, the process advances to Step S510, in which the CPU 710 notifies the user that the write operation has failed to end the processing. In Step S510, an error message may be displayed on an LCD monitor (not shown in FIG. 7) or an LED lamp may be blinked, thereby notifying the user of the failure of the write operation.

### Find Common Space Left

In the next processing step S520, a common space left, where the write operation should be continued, is found. The common space left is found in the same way as in the processing step S430 shown in FIG. 10, and the description thereof will be omitted herein. However, in this processing step S520, the CPU 710 has only to find a minimum required common space left for continuing the write operation, e.g., a space with a size of 1 AU. And when a space with a size of 1 AU is found, the CPU 710 decides that the write operation can be continued (OK). On the other hand, if no common space left with a size of 1 AU can be found, the process advances to Step S550, in which the CPU 710 performs a write operation ending process. In that case, the CPU 710 retains a flag indicating that an error has occurred in the main memory.

### Write AV Data

In the next processing step S530, AV data writing processing is carried out. The CPU 710 sends a command to change the modes of operation of the control section 820 into the single-card mode to the control section 820 and writes data on the common space left that has been detected in the previous processing step S520. In this case, the address specified by the write command issued to the control section 820 is defined with respect to the top address of the data area. The top address of the data area has already been obtained in the processing step S410 shown in FIG. 10. On receiving the write command, the control section 820 of the memory card adapter 800 copies the data, adds the respective addresses of the data start areas of the first and second memory cards 850 and 860 that have been set in the processing step S420 shown in FIG. 10 to the address specified by the write command, and issues a write command to the first and second memory cards 850 and 860. In this case, if the write command has not been accepted by at least one of the first and second memory cards 850 and 860 due to the presence of a defective block, for example, the process advances to Step S550, in which the CPU 710 performs the write operation ending process. In that case, the CPU 710 retains a flag indicating that an error has occurred in the main memory. On the other hand, if the write command has been accepted successfully, the CPU 710 sends a command to change the modes of operation of the control section 820 into the multi-card mode to the control section 820 and the process advances to Step S540.

### Determine Whether or not to Continue Writing

In the next processing step S540, the CPU 710 determines whether or not the write operation should be continued, i.e., whether or not the user has sent an instruction to stop writing. The user may send an instruction to stop writing by pressing a switch or a button (not shown in FIG. 7), for example. If the write operation should be continued, the process goes back to Step S520, in which the CPU 710 continues the processing. On the other hand, if the write operation should be stopped, then the process advances to Step S550, in which the CPU 710 performs the write operation ending process.

### Write Operation Ending Process

In the processing step S550, the directory entry of the AV file that has been written in Step S500 is updated. Specifically, first of all, the CPU 710 writes the overall size of the AV data that has been written in the processing step S530 into the file size of the directory entry of the AV file in the first and second memory cards 850 and 860. The CPU 710 further writes the top cluster number of the AV data into the top data position. As for the top data position, the CPU 710 may write it when the position is fixed. On the other hand, the file size may be updated every time the AV data is written in Step S530. Also, the CPU 710 writes the directory entry after changing the modes of operation of the memory card adapter 800 into the multi-card mode. If there is a flag indicating the occurrence of an error in the main memory of the CPU 710, then in Step S510, the CPU 710 notifies the user that the write operation has failed and ends the process.

In this manner, the AV data writing process including these processing steps S500 through S550 shown in FIG. 11 gets done. According to this preferred embodiment, these processing steps are carried out by the CPU 710 in the information writing device 700.

Although the information writing device 700 has no simultaneous write function by itself, the information writing device 700 can still write the same data on both of the first and second memory cards 850 and 860 at the same time just by connecting the memory card adapter 800 of this preferred embodiment to the device 700 and by changing the software of the CPU 710 of the information writing device 700. In particular, according to the processing of this preferred embodiment, the simultaneous write operation can be performed on two memory cards 860 that have mutually different specifications, card storage capacities, partition positions, sizes and file system types.

### Embodiment 4

Next, a fourth specific preferred embodiment of the present invention will be described. According to the third preferred embodiment described above, a simultaneous write function using a memory card adapter 800 is provided by connecting the memory card adapter 800 to an information writing device 700 that performs a write operation on a single memory card 760 and by partially modifying the control software of the information writing device 700. On the other hand, according to this preferred embodiment, the simultaneous write function can be provided without using a memory card adapter. The following description of this fourth preferred embodiment will be focused on only the differences from the third preferred embodiment described above and their common features will not be described all over again to avoid redundancies.

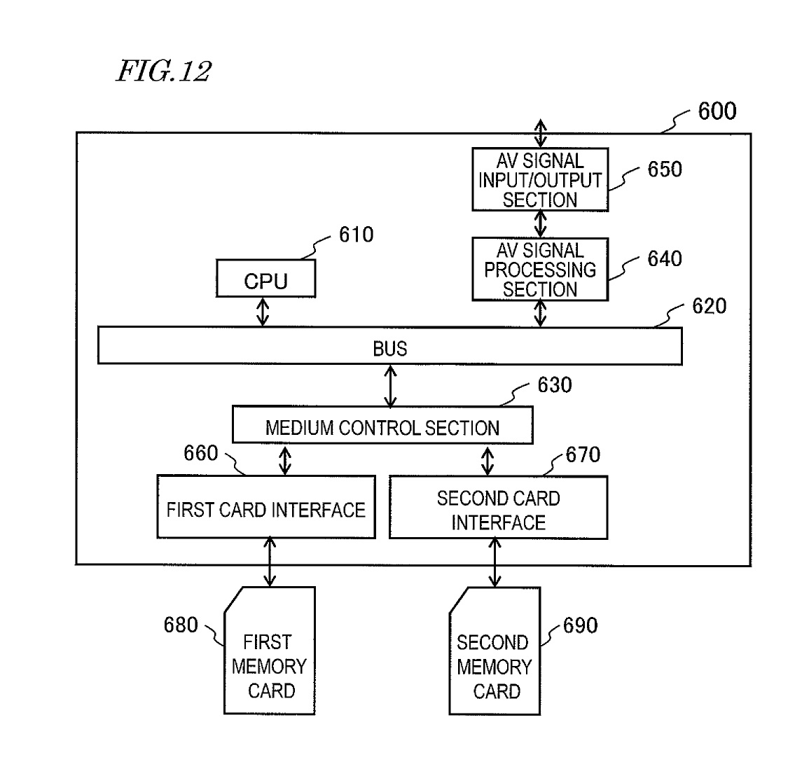

FIG. 12 is a block diagram illustrating a configuration for an information writing device 600 as a fourth preferred embodiment of the present invention. As shown in FIG. 12, the information writing device 600 includes a CPU 610, a bus 620, a medium control section 630, an AV signal processing section 640, an AV signal input/output section 650, a first card interface 660 and a second card interface 670. First and second memory cards 680 and 690 are attached to this information writing device 690.

The CPU 610, the bus 620, the AV signal processing section 640, and the AV signal input/output section 650 are respectively equivalent to the CPU 710, the bus 720, the AV signal processing section 740, and the AV signal input/output section 750 of the information writing device 700 shown in FIG. 7, and therefore, description thereof will be omitted herein. It should be noted, however, that the software (program) for operating the CPU 610 is modifiable afterward according to this preferred embodiment, too. Meanwhile, the medium control section 630 and the first and second card interfaces 660 and 670 respectively have the same functions as the control section 820 and the first and second card interfaces 830 and 840 shown in FIG. 8.

The medium control section 630 controls accesses to the first and second memory cards 680 and 690 through the first and second card interfaces 660 and 670, respectively. The software (program) for operating the medium control section 630 is also modifiable afterward. According to this preferred embodiment, the software for operating the medium control section 630 is supposed to have been changed so as to have the function of performing a simultaneous write operation on the first and second memory cards 680 and 690.

In writing video and/or audio on the first and second memory cards 680 and 690, the video and/or audio that has been input through the AV signal input/output section 650 is subjected to signal processing by the AV signal processing section 640 to be encoded digital AV data. That AV data is transferred through the bus 620 and then written by the CPU 610 as a file on the first or second memory card 680 or 690. In this case, it is either the first memory card 680 or the second memory card 690 that the AV data is written on. That is to say, the path leading from the AV signal processing section 640 to the medium control section 630 through the bus 620 has only a transfer capability of transmitting one stream of AV data and does not have a transfer capability of transmitting multiple streams of AV data at a time to perform a simultaneous write operation. Consequently, only with the information writing device 600 having the configuration shown in FIG. 12, it is difficult to perform a simultaneous write operation on multiple memory cards for backup purposes. Thus, according to this preferred embodiment, the function of performing a simultaneous write operation on the first and second memory cards 680 and 690 is performed by changing the software for the CPU 610 and the medium control section 630.

After having sent a command to the medium control section 630 and confirmed that first and second memory cards 680 and 690 are both connected and accessible, the CPU 610 sees if the first and second memory cards 680 and 690 satisfy the condition of simultaneous writing. Hereinafter, it will be described with reference to a flowchart how to examine whether the condition of simultaneous writing is satisfied or not.

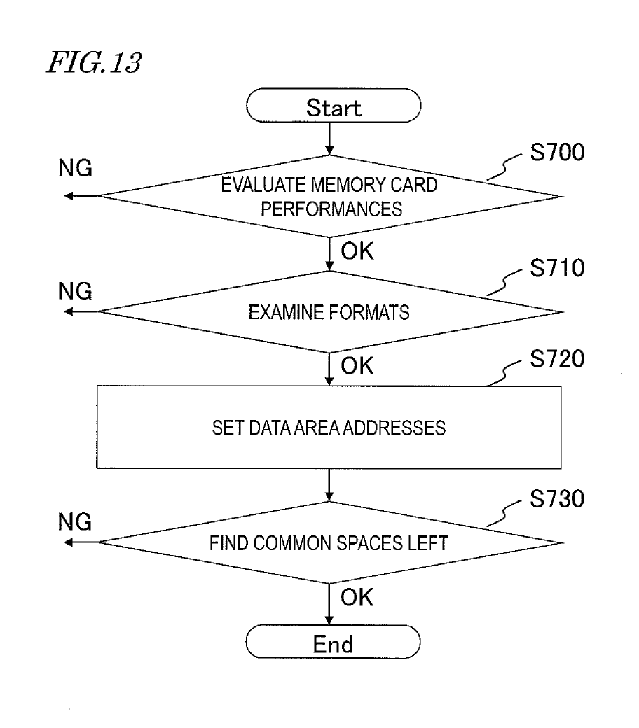

FIG. 13 is a flowchart showing the procedure of a memory card testing method according to this preferred embodiment. As shown in FIG. 13, the first and second memory cards 680 and 690 have their card performances evaluated in Step S700, have their formats examined in Step S710, have the address of their data area (where data is going to be written) set in Step S720, and have their common space left found in Step S730.

Hereinafter, the respective processing steps of the card testing method shown in the flowchart of FIG. 13 will be described in detail one by one.

### Evaluate Performances

In the first processing step S700, the CPU 610 evaluates the performances of the first and second memory cards 680 and 690 that are currently attached to the information writing device 600. Since this processing step is the same as the processing step S400 of the third preferred embodiment described above, a detailed description thereof will be omitted herein.

The CPU 610 issues and sends a command to the medium control section 630. In response to the command, the medium control section 630 transfers that command to the first memory card 680 by way of the first card interface 660, thereby getting a numerical value representing the card performance from the first memory card 680. Next, the CPU 610 transfers the command to the second memory card 690 by way of the second card interface 670, thereby getting a numerical value representing the card performance from the second memory card 690.

Then, the CPU 610 examines whether the card performance values of the first and second memory cards 680 and 690 thus obtained are both equal to or greater than a minimum required performance value. If the card performance values of the first and second memory cards 680 and 690 both turn out to be equal to or greater than the minimum required performance value, the CPU 610 decides that there is no performance value problem (OK) and the process advances to the next processing step S710. However, if the performance value(s) of one or both of the first and second memory cards 680 and 690 turn(s) out to be less than the minimum required performance value, the CPU 610 decides that the simultaneous write operation cannot get done (NG) to end this testing process.

### Examine Formats

In the next processing step S710, the CPU 610 examines the formats of the first and second memory cards 680 and 690 that are currently attached to the information writing device 600. Since this format examining processing step is the same as the processing step S410 of the third preferred embodiment described above, a detailed description thereof will be omitted herein. If the format of at least one of the first and second memory cards 680 and 690 fails to be compliant with the standard, then the CPU 610 decides that the simultaneous write operation cannot get done (NG) to end this testing process.

### Set Data Area Addresses

In the next processing step S720, the addresses of the data areas are set. The data area addresses are calculated based on the file system parameters that have been obtained in the previous processing step S710 described above. The CPU 610 sends a data area set command to the medium control section 630, thereby setting the data area addresses of the first and second memory cards 680 and 690.

### Check Cards for Spaces Left

Next, in the processing step S730, the CPU 610 checks out the first and second memory cards 680 and 690 to see if they have any common spaces left. Such a common space left is found as in the processing step S430 of the third preferred embodiment described above, and description thereof will be omitted herein.

In this manner, the testing process including these processing steps S700 through S730 shown in FIG. 13 gets done. These processing steps are carried out by the CPU 610 in the information writing device 600. If the decision of every one of the testing processing steps shown in FIG. 13 is OK, then the simultaneous write operation can be accepted.

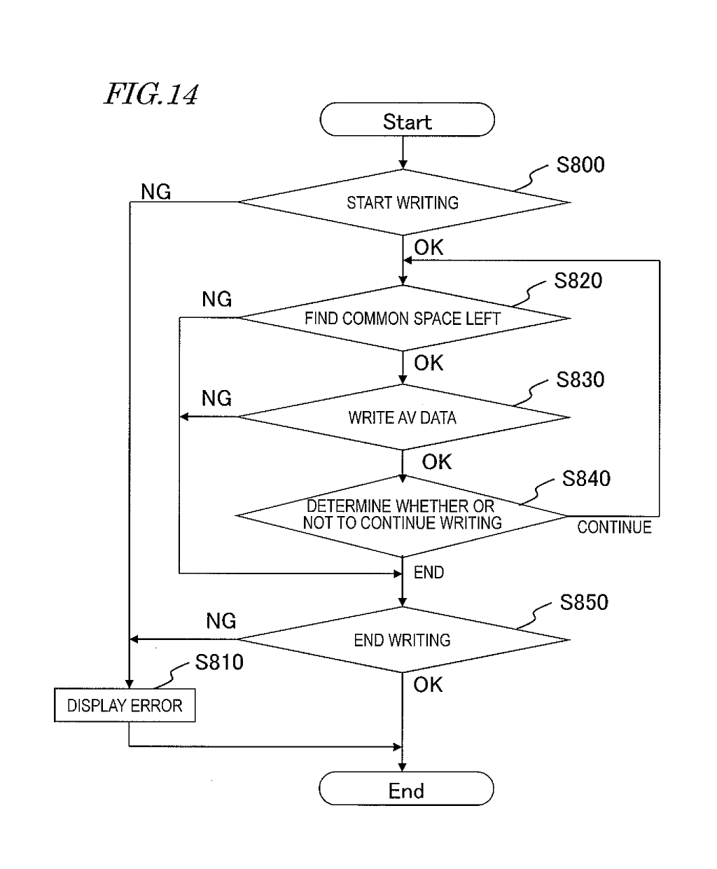

FIG. 14 is a flowchart showing the procedure of an AV data writing method according to this preferred embodiment. As shown in FIG. 14, this procedure includes the step S800 of starting writing AV data, the step S810 of displaying an error if any, the step S820 of finding a common space left, as an area where data is going to be written, in the first and second memory cards 680 and 690, the step S830 of writing the AV data, the step S840 of determining whether the write operation should be continued or not, and the step S850 of ending the AV data writing operation.

Hereinafter, the respective processing steps of the AV data writing method shown in the flowchart of FIG. 14 will be described in detail one by one.

### Start Writing

In the first processing step S800, as a write operation is started, an AV file is generated in a predetermined directory. The CPU 610 retrieves a predetermined directory from each of the first and second memory cards 680 and 690 in the multi-card mode and examines whether or not there is any file that has the same name as the AV file to make in that directory. If the answer is YES, the CPU 610 decides that the simultaneous write operation cannot get done (NG).

On the other hand, if there is no file that has the same name, then CPU 610 decides that the simultaneous write operation could get done (OK) and writes a directory entry in the predetermined directory of each of the first and second memory cards 680 and 690 in the multi-card mode. Although the directory entry does include a file name and the date of generation, the file size and the location of the top data have not been determined yet and therefore set to be zero.

If the decision made in Step S800 is NG, the process advances to Step S810, in which the CPU 610 notifies the user that the write operation has failed to end the processing. In Step S810, the CPU 610 may display an error message on an LCD monitor (not shown in FIG. 12) or may blink an LED lamp, thereby notifying the user of the failure of the write operation.

### Find Common Space Left

In the next processing step S820, a common space left, where the write operation should be continued, is found. The common space left is found in the same way as in the processing step S430 shown in FIG. 10, and the description thereof will be omitted herein. However, in this processing step S820, the CPU 610 has only to find a minimum required common space left for continuing the write operation, e.g., a space with a size of 1 AU. And when a space with a size of 1 AU is found, the CPU 610 decides that the write operation can be continued (OK). On the other hand, if no common space left with a size of 1 AU can be found, the process advances to Step S850, in which the CPU 610 performs a write operation ending process. In that case, the CPU 610 retains a flag indicating that an error has occurred in the main memory.

### Write AV Data

In the next processing step S830, AV data writing processing is carried out. The CPU 610 sends a command to change the modes of operation of the medium control section 630 into the single-card mode to the medium control section 630 and writes data on the common space left that has been detected in the previous processing step S820. In this case, the address specified by the write command issued to the medium control section 630 is defined with respect to the top address of the data area. The top address of the data area has already been obtained in the processing step S710 shown in FIG. 13. On receiving the write command, the medium control section 630 copies the data, adds the respective addresses of the data areas of the first and second memory cards 680 and 690 that have been set in the processing step S720 shown in FIG. 13 to the address specified by the write command, and issues a write command to the first and second memory cards 680 and 690. In this case, if the write command has not been accepted by at least one of the first and second memory cards 680 and 690 due to the presence of a defective block, for example, the process advances to Step S850, in which the CPU 610 performs the write operation ending process. In that case, the CPU 610 retains a flag indicating that an error has occurred in the main memory. On the other hand, if the write command has been accepted successfully, the CPU 610 sends a command to change the modes of operation of the medium control section 630 into the multi-card mode to the medium control section 630 and the process advances to Step S840.

### Determine Whether or not to Continue Writing

In the next processing step S840, the CPU 610 determines whether or not the write operation should be continued, i.e., whether or not the user has sent an instruction to stop writing. The user may send an instruction to stop writing by pressing a switch or a button (not shown in FIG. 12), for example. If the write operation should be continued, the process goes back to Step S820, in which the CPU 610 continues the processing. On the other hand, if the write operation should be stopped, then the process advances to Step S850, in which the CPU 610 performs the write operation ending process.

In the processing step S850, the directory entry of the AV file that has been written in Step S800 is updated. Specifically, first of all, the CPU 610 writes the overall size of the AV data that has been written in the processing step S830 into the file size of the directory entry of the AV file in the first and second memory cards 680 and 690. The CPU 610 further writes the top cluster number of the AV data into the top data position. As for the top data position, the CPU 610 may write it when the position is fixed. On the other hand, the file size may be updated every time the AV data is written in Step S830. Also, the CPU 610 writes the directory entry after changing the modes of operation of the medium control section 630 into the multi-card mode. If there is a flag indicating the occurrence of an error in the main memory of the CPU 610, then in Step S810, the CPU 610 notifies the user that the write operation has failed and ends the process.

Although the information writing device 600 has no simultaneous write function by itself, the function of performing a simultaneous write operation on the first and second memory cards 680 and 690 is provided just by changing the software for the CPU 610 of the information writing device 600 and for the medium control section 630 so that the processing described above is carried out.

In the third and fourth preferred embodiments of the present invention described above, the data area start addresses of the two memory cards are set with respect to either the control section 820 or the medium control section 630. If the mode of operation of the memory card adapter 800 or the medium control section 630 is the single-card mode, the address specified by the write command is defined with respect to the start address of the data area that has been set. However, this is just an example of the present invention. Alternatively, one of the two memory cards may be regarded as a master card and the difference in data area start address between the master card and the other memory card may be set with respect to the control section 820 or the medium control section 630. In that case, if the memory card adapter 800 or the medium control section 630 operates in the single-card mode, the address to write data on the master card is specified by the write command. In that case, on receiving the write command, the control section 820 of the memory card adapter 800 or the medium control section 630 conveys the write command to the master card without changing the address specified but conveys the write command to the other memory card along with the difference in data area address that has been set. A simultaneous write operation can be performed on two memory cards in this manner, too.

Also, in the third and fourth preferred embodiments of the present invention described above, two memory cards on which a simultaneous write operation is going to be performed are checked out to see if one data management block size of one of the two cards is a multiple of that of the other. However, such a relation is not always satisfied according to the present invention. Even if one data management block size of one of the two memory cards is not a multiple of that of the other, a common offset, corresponding to a common multiple of the two block sizes, could also be produced. That is why in Step S430 shown in FIG. 10 or in Step S730 shown in FIG. 13, a common space left may be searched for by using, as unit, a size that corresponds to the least common multiple of the management block sizes of the two memory cards.

Furthermore, in the third and fourth preferred embodiments of the present invention described above, the modes of operation of the memory card adapter 800 and the medium control section 630 are supposed to be changed from the multi-card mode into the single-card mode. However, according to the present invention, this method does not always have to be adopted but a simultaneous write operation can also be performed without changing from the multi-card mode, too. In that case, a status in which the first and second memory cards 850 and 860 are recognizable for the information writing device 700 through the memory card adapter 800 is maintained. In the same way, a status in which the first and second memory cards 680 and 690 are recognizable for the information writing device 600 is also maintained. In that case, in writing AV data, the information writing device 700 or 600 may add a copy flag to the write command and issue such a command with respect to the memory card adapter 800 or the medium control section 630. If the command that has been received from the information writing device 700 or 600 has a copy flag added, the control section 820 of the memory card adapter 800 or the medium control section 630 copies that command and then conveys that command to the first and second memory cards 850 and 860 or 680 and 690 attached. Even so, a simultaneous write operation can also be performed on the first and second memory cards 850 and 860 or 680 and 690. Optionally, instead of adding a copy flag to the command, a special copy command, which is different from a normal command, may be issued separately. If the command that has been received from the information writing device 700 or 600 is a copy command, the control section 820 of the memory card adapter 800 or the medium control section 630 copies that command and then conveys that command to the first and second memory cards 850 and 860 or 680 and 690 attached at the same time. Even so, a simultaneous write operation can also be performed on the first and second memory cards 850 and 860 or 680 and 690.

According to the third preferred embodiment of the present invention described above, specific examples of standards that the memory card adapter 800 should be compliant with include the PC Card standard, the Express Card standard and the CompactFlash standard. The “PC Card standard” and the “Express Card standard” are memory card standards that were established by a standardization organization called PCMCIA (Personal Computer Memory Card International Association). The “CompactFlash standard” is a memory card standard that was set up by CFA (CompactFlash Association).

Specifically, the memory cards 850, 860, 680 and 690 of the third and fourth preferred embodiments of the present invention described above may be compliant with the SD Memory Card standard. Examples of memory cards compliant with the SD Memory Card standard include mini SD memory cards, micro SD memory cards, SDHC cards and SDXC cards. According to the fourth preferred embodiment, specific examples of the memory cards 680 and 690 may be compliant with the PC Card standard, the Express Card standard, or the CompactFlash standard as well.

Nevertheless, not all of the multiple memory cards for use in the third and fourth preferred embodiments of the present invention described above have to have the same specifications or be compliant with the same standard. For example, the first memory cards 850 and 680 may be compliant with the SD Memory Card standard and the second memory cards 860 and 690 may be compliant with the CompactFlash standard.

Furthermore, according to the third preferred embodiment of the present invention described above, the information writing device 700 may use a USB memory or a USB hard disk as an external storage medium to attach instead of memory cards. In that case, the card interface 730 of the information writing device 700 may be a USB interface. On the other hand, if the host interface 810 of the memory card adapter 800 is a USB interface, then a memory card adapter that can be inserted into a USB interface is obtained. By connecting such a memory card adapter to the information writing device, a write operation can be performed on multiple memory cards simultaneously.

In the third and fourth preferred embodiments of the present invention described above, two memory cards are supposed to be attached to the memory card adapter 800 or the information writing device 600. However, three or more memory cards may also be attached to the memory card adapter 800 or the information writing device 600. In that case, the memory card adapter 800 or the information writing device 600 can perform the operation of writing AV data simultaneously on at least two of the multiple memory cards attached.

Furthermore, as in the first and second preferred embodiments of the present invention described above, the user may specify, by using either the information writing device 700, 600 or an external device, which ones of those testing processing steps need to be carried out and which ones may be skipped, in the third and fourth preferred embodiments, too. In that case, minimum required testing processing steps may be carried out with no time wasted. According to the present invention, it may be determined, based on at least one of various pieces of information about the storage capacities, transfer capabilities, file system formats, and space left of respective storage media, whether a simultaneous write operation can be performed or not.

A memory card adapter and information writing device according to any of various preferred embodiments of the present invention described above can be used effectively to write the same data on multiple memory cards simultaneously.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

This application is based on Japanese Patent Applications No. 2010-271054 filed Dec. 6, 2010 and No. 2011-031583 filed Feb. 17, 2011, and No. 2011-245841 filed Nov. 9, 2011, the entire contents of which are hereby incorporated by reference.

What is claimed is:

1. A storage medium adapter, to/from which multiple storage media are attachable and removable, the adapter comprising:
storage medium interfaces, to which the multiple storage media are to be connected;
a host interface, which is to be connected to an external device; and
a control section, which is electrically connected to the storage medium interfaces and the host interface,
wherein the control section determines, based on information that has been obtained from the multiple storage media through the storage medium interfaces, whether or not same data can be written on those storage media simultaneously, and
wherein if it turns out that the same data can be written on the multiple storage media simultaneously, the control section writes data that has been received by way of the host interface on the respective storage media.

2. The storage medium adapter of claim 1, wherein the control section determines, based on at least one of pieces of information about the storage capacities, transfer capabilities, file system formats, and spaces left of the respective storage media, whether or not the same data can be written on the multiple storage media simultaneously.

3. The storage medium adapter of claim 1, wherein if the control section has received, by way of the host interface, a write command to write data on the multiple storage media, the control section copies the write command and transmits the copied write command to the respective storage media.

4. The storage medium adapter of claim 1, wherein if the control section has received, by way of the host interface, a read command to read data from the multiple storage media, the control section transmits the read command to one of those storage media and then forwards a response from that storage medium by way of the host interface.

5. An information writing system comprising a storage medium adapter, to/from which multiple storage media are attachable and removable, and an information writing device, to/from which the storage medium adapter is connectable and disconnectible,
wherein the information writing device includes:
an adapter interface, to which the storage medium adapter is to be connected; and
a first control section, which is electrically connected to the adapter interface, and
wherein the storage medium adapter includes:
storage medium interfaces, to which the multiple storage media are to be connected;
a host interface, which is to be connected to the information writing device; and
a second control section, which is electrically connected to the storage medium interfaces and the host interface,
wherein the first control section determines, based on information about the multiple storage media that has been obtained from the storage medium adapter through the adapter interface, whether or not same data can be written on those storage media simultaneously, and if it turns out that the same data can be written on the multiple storage media simultaneously, the first control section transmits a write command to write data to the storage medium adapter by way of the adapter interface, and
wherein if the second control section has received the write command by way of the host interface, the second control section copies the write command and transmits the copied write command to the respective storage media by way of the storage medium interfaces.

6. The information writing system of claim 5, wherein the first control section determines, based on at least one of pieces of information about the storage capacities, transfer capabilities, file system formats, and spaces left of the respective storage media, whether or not the same data can be written on the multiple storage media simultaneously.

7. The information writing system of claim 5, wherein the second control section is able to change its modes of operation from a first mode in which a command that has been received from the information writing device by way of the host interface is transmitted to every one of the storage media, into a second mode in which the command is transmitted to only one of the storage media, and vice versa.

8. The information writing system of claim 5, wherein the first control section detects the start address of the data area of each said storage medium, sets each said storage medium's start address detected to the storage medium adapter, and then transmits the write command to the storage medium adapter, and
wherein on receiving the write command, the second control section determines, based on each said storage medium's start address that has been set, where data should be written on each said storage medium.

9. The information writing system of claim 8, wherein the write command specifies, by an address that is defined with respect to the start address of each said storage medium's data area, where data should be written, and
wherein on receiving the write command, the second control section adds each said storage medium's start address to the address specified by the write command and then writes the data at an address that is specified by the sum of the two addresses.

10. The information writing system of claim 8, wherein the first control section is able to transmit a first kind of command that gives an instruction to only a particular one of the storage media at a time and a second kind of command that gives an instruction to every one of the storage media at the same time, obtains file management information from each said storage medium by using the first kind of command, and writes data on the multiple storage media simultaneously by using the write command as the second kind of command.

11. The information writing system of claim 8, wherein before writing data on the multiple storage media simultaneously, the first control section obtains information about the performance of each said storage medium and the file management information thereof by using the first kind of command, and determines, based on the information about each said storage medium's performance and the file management information thus obtained, whether or not data can be written on the multiple storage media simultaneously.

12. An information writing device, to/from which multiple storage media are attachable and removable,
wherein the information writing device includes:
storage medium interfaces, to which the multiple storage media are to be connected;
a first control section, which issues a write command to write data on the multiple storage media simultaneously; and
a second control section, which is electrically connected to the storage medium interfaces and the first control section,
wherein the first control section detects the start address of the data area of each said storage medium, sets each said storage medium's start address detected to the second control section, and then transmits the write command to the second control section, and
wherein on receiving the write command, the second control section determines, based on each said storage medium's start address that has been set, where data should be written on each said storage medium.

13. The information writing device of claim 12, wherein the write command specifies, by an address that is defined with respect to the start address of each said storage medium's data area, where data should be written, and
wherein on receiving the write command, the second control section adds each said storage medium's start address to the address specified by the write command and then writes the data at an address that is specified by the sum of the two addresses.

14. The information writing system of claim 12, wherein the first control section is able to transmit a first kind of command that gives an instruction to only a particular one of the storage media at a time and a second kind of command that gives an instruction to every one of the storage media at the same time, obtains file management information from each said storage medium by using the first kind of command, and writes data on the multiple storage media simultaneously by using the write command as the second kind of command.

15. The information writing device of claim 12, wherein before writing data on the multiple storage media simultaneously, the first control section obtains information about the performance of each said storage medium and the file management information thereof by using the first kind of command, and determines, based on the information about each said storage medium's performance and the file management information thus obtained, whether or not data can be written on the multiple storage media simultaneously.
